(19) United States
(12) Patent Application Publication
(10) Pub. No.: US 2015/0171522 A1
(43) Pub. Date: Jun. 18, 2015

(54) ANTENNA UNIT, ANTENNA ASSEMBLY, MULTI-ANTENNA ASSEMBLY, AND WIRELESS CONNECTION DEVICE

(71) Applicant: KUANG-CHI INNOVATIVE TECHNOLOGY LTD., Shenzhen (CN)

(72) Inventors: Ruopeng LIU, Shenzhen (CN); Guanxiong XU, Shenzhen (CN); Jing LV, Shenzhen (CN); Chunfeng LI, Shenzhen (CN); Cunxi DENG, Shenzhen (CN); Shuangshuang LI, Shenzhen (CN); Yuchang YANG, Shenzhen (CN); Liuzhong YIN, Shenzhen (CN)

(73) Assignee: KUANG-CHI INNOVATIVE TECHNOLOGY LTD., Shenzhen (CN)

(21) Appl. No.: 14/621,404

(22) Filed: Feb. 13, 2015

Related U.S. Application Data
(63) Continuation of application No. PCT/CN2013/081239, filed on Aug. 9, 2013.

(30) Foreign Application Priority Data
Aug. 13, 2012 (CN) 201210286511.5
Aug. 13, 2012 (CN) 201210286555.8
Sep. 24, 2012 (CN) 201210385136.X
Dec. 19, 2012 (CN) 201210554682.1
Mar. 28, 2013 (CN) 201310105507.9

(51) Int. Cl. H01Q 19/30; H01Q 21/20

(52) U.S. Cl. CPC H01Q 19/30; H01Q 21/20

(57) ABSTRACT

The present invention relates to an antenna unit, including a dielectric substrate and an antenna conductor attached to the dielectric substrate, where a maximum gain direction of the antenna unit is consistent with an extension direction of a surface of the dielectric substrate. The present invention also relates to an antenna assembly with the antenna unit, a multi-antenna assembly, and a wireless connection device with the antenna unit, the antenna assembly or the multi-antenna assembly. The antenna unit of the present invention has high directivity, and has advantages of broad bands, high gains, and easy commissioning, so that both the multi-antenna assembly and the wireless connection device have high performance.

### CROSS REFERENCE TO RELATED APPLICATIONS

This application is a continuation of PCT/CN2013/081239 filed on Aug. 9, 2013, which claims priority to Chinese patent application No. 201210286511.5 of Aug. 13, 2012; Chinese patent application No. 201210286555.8 of Aug. 13, 2012; Chinese patent application No. 201210385136.X of Sep. 24, 2012; Chinese patent application No. 201210554682.1 of Dec. 29, 2012; and Chinese patent application No. 201310105507.9 of Mar. 28, 2013; all of which are incorporated herein by reference.

### TECHNICAL FIELD

The present invention relates to the field of wireless communications components, and in particular, to an antenna unit, an antenna assembly, a multi-antenna assembly, and a wireless connection device.

### BACKGROUND

A conventional distributed antenna system can overcome a channel path loss caused by large scale fading and shadow fading, and form good system coverage in a cell, thereby solving dead zones in a cell and improving communication quality of service. With rapid development of the wireless mobile internet, new network protocols such as IEEE 802.11a/g/b/n/ac impose higher requirements on wireless mobile internet devices and systems, and also impose higher technical parameter requirements on antenna design. Therefore, antennas, antenna systems, and applications of the antennas and antenna systems, which are used to improve wireless electronic devices, need to be provided. For example, the applications of the antennas and antenna systems includes applications, such as a wireless access device, a MIMO communications device, and a wireless routing device.

A Yagi antenna, also called a Yagi-Uda antenna, is generally in a shape of “ [symbol] ”. A main element (also called an active element) is located at the center of the “ [symbol] ”, and is connected to a feeder. A reflector is located on a side of the main element to serve a purpose of weakening electromagnetic waves on this side, and is a little longer than the main element. A director is located on the other side of the main element, and is a little shorter than the main element and is used to enhance electromagnetic waves on this side.

The Yagi antenna has advantages of high directivity, and is highly effective in direction finding and long-haul communication. However, existing Yagi antennas, which are all made of metal rods, are large in size, occupy large space, and are primarily used outdoors. How to apply advantages of the Yagi antenna to wireless-coverage small antennas such as a ceiling antenna and a wireless router is an issue that the present invention intends to solve. In addition, existing wireless network requirements also impose higher requirements on a gain of an antenna.

An existing Chinese invention patent CN 102800954 A discloses an antenna unit, which includes a dielectric substrate, a main element used for connecting to a feeder, and a director used to enhance a radio wave on a side where the director is located, where both the main element and the director are conductor wires attached to the dielectric substrate. The foregoing patent also relates to an antenna assembly, which includes a dielectric reflection surface used to reflect radio waves used by the antenna assembly, and an antenna group located on the side of the dielectric reflection surface. The antenna group includes at least one of the foregoing antenna unit, and the dielectric reflection surface and the director of each antenna unit are separately located on two sides of a main element of the corresponding antenna unit. The foregoing patent also relates to a multi-antenna assembly with multiple foregoing antenna groups. A defect of the foregoing patent lies in that: an arrangement manner of each antenna unit in the antenna assembly leads to poor overall receiving performance of the antenna assembly.

### SUMMARY

In view of the foregoing problems, the present invention provides an antenna unit, an antenna assembly, a multi-antenna assembly and a wireless connection device. Specifically, the present invention provides a miniature antenna unit, an antenna assembly, and a multi-antenna assembly that are based on Yagi antenna principles. Further, the present invention provides a miniature high-gain antenna unit and a multi-antenna assembly that are based on Yagi antenna principles. Further, the present invention provides an antenna (multi-antenna assembly), so as to achieve at least high overall receiving performance of the antenna (multi-antenna assembly).

A first aspect of the present invention provides an antenna unit, including a dielectric substrate and an antenna conductor attached to the dielectric substrate, where a maximum gain direction of the antenna unit is consistent with an extension direction of a surface of the dielectric substrate.

Further, the dielectric substrate is made of a material with a dielectric constant less than 10 and a loss angle tangent value less than 0.04.

Further, the dielectric substrate is made of a material with a dielectric constant less than 6.5 and a loss angle tangent value less than 0.009.

Further, the dielectric substrate is made of one or two or more than two materials.

Further, the dielectric substrate is an epoxy board, a polytetrafluoroethylene board, a Teflon board, a halogen-free board, a Rogers high frequency board or a ceramic board.

Further, the dielectric substrate is made of a metamaterial board, where the metamaterial board includes a substrate and a microstructure attached to the substrate.

Further, a size of the microstructure is less than half of an electromagnetic wave wavelength corresponding to an operating frequency of the antenna unit.

Further, a size of the microstructure is less than a quarter of an electromagnetic wave wavelength corresponding to an operating frequency of the antenna unit.

Further, a size of the microstructure is less than one-sixth of an electromagnetic wave wavelength corresponding to an operating frequency of the antenna unit.

Further, the antenna conductor includes a main element used for connecting to a feeder, and a director used to enhance a radio wave on a radio side, where both the main element and the director are conductor wires attached to the dielectric substrate.

Further, the director is a radial structure that is formed of a conductor material and disposed along a propagation direction of an electromagnetic wave.

Further, the main element is a straight line or a curve.

Further, a width of the conductor wire of the main element is homogeneously equal or incompletely equal.

Further, the main element is a splayed curve ring or a splayed polyline ring.

Further, the main element is a rhombic ring, circular ring, rectangular ring, triangular ring, or polygonal ring that is splayed at any corner.

Further, the dielectric substrate includes two surfaces, and at least one director is disposed on another surface that is different from a surface on which the main element is located.

Further, the antenna conductor includes a first antenna conductor disposed on one surface of the dielectric substrate and a second antenna conductor that is disposed on another surface.

Further, the antenna unit includes multiple layers of dielectric substrates, and the antenna conductor is disposed on one or more of the multiple layers of dielectric substrates.

Further, the conductor wire is a metal wire.

Further, there are multiple directors, which constitute a group of conductor wires that are parallel to each other.

Further, centers of the multiple directors are on a same straight line, and the straight line is vertical to the directors.

Further, the main element includes two collinear conductor wires, which are parallel to the conductor wires of the directors respectively.

Further, a total length of the main element is greater than a length of each director.

Further, the antenna conductor includes a main element and at least one director that are disposed apart on a surface of the dielectric substrate, both the main element and the director are conductor strips, and both ends of the main element are a feed point and a ground point respectively.

Further, the main element is a splayed curve ring or a splayed polyline ring, and the feed point and the ground point are located at ends of a splay separately.

Further, some of the conductor strips at the splay have overlaps, and overlaps are spaced apart to form the splay.

Further, the conductor strips with the overlaps take on two opposite L shapes.

Further, the conductor strips are metal wires, wires formed of a nonmetal conductive substance, or conductive wires formed of a metal and a nonmetal.

Further, there are multiple directors, which constitute a group of conductor strips that are parallel to each other.

Further, the main element is a rhombic ring that is splayed at any corner.

Further, the dielectric substrate includes two surfaces, and at least one director is disposed on another surface that is different from a surface on which the main element is located.

A second aspect of the present invention provides an antenna assembly, including a dielectric reflection surface used to reflect radio waves used by the antenna assembly, and an antenna group located on a side of the dielectric reflection surface, where the antenna group includes at least one antenna unit according to any one of the implementation manners 10 to 31 in the first aspect of the present invention, and the dielectric reflection surface and a director of each antenna unit are separately located on two sides of a main element of a corresponding antenna unit.

Further, the antenna group includes three same antenna units, a dielectric substrate of each antenna unit is vertical to the dielectric reflection surface, and the three antenna units are 120 degrees apart from each other, use a same straight line as an extension intersection line and are equidistant to the extension intersection line.

Further, the antenna group includes three same antenna units, a dielectric substrate of each antenna unit is vertical to the dielectric reflection surface, and the three antenna units are 60 degrees apart from each other, and dielectric substrates of the three antenna units intersect to form an equilateral triangle after extending along a direction of their respective surface.

A third aspect of the present invention provides a multi-antenna assembly, including a dielectric reflection surface and at least one antenna group installed on the dielectric reflection surface, where radio wave frequencies used by different antenna groups are different, and each antenna group includes at least one antenna unit according to any one implementation manner of the first aspect of the present invention.

Further, the dielectric reflection surface is a conductive microstructure with a geometric pattern.

Further, a size of the conductive microstructure is less than half of a wavelength corresponding to a radio wave frequency used by the antenna group.

Further, a size of the conductive microstructure is less than a quarter of a wavelength corresponding to a radio wave frequency used by the antenna group.

Further, a size of the conductive microstructure is less than one-sixth of a wavelength corresponding to a radio wave frequency used by the antenna group.

Further, the multi-antenna assembly includes two antenna groups which are a first antenna group and a second antenna group, and main elements of antenna units of the two antenna groups have different sizes.

Further, the multi-antenna assembly includes two antenna groups which are a first antenna group and a second antenna group, the first antenna group and the second antenna group include the same number of antenna units, and antenna units of the first antenna group are spaced apart by antenna units of the second antenna group.

Further, the multi-antenna assembly includes two antenna groups which are a first antenna group and a second antenna group, the first antenna group and the second antenna group include their respective same antenna units, and their respective antenna units are evenly distributed on the dielectric reflection surface in an angular array manner.

Further, a reflector is disposed outside each antenna unit.

Further, the reflector is a splayed structure that is small at one end and big at the other end, and the splay is oriented to a maximum gain direction of the antenna unit.

Further, at least two antenna groups are included, where the antenna unit of each antenna group is the antenna unit according to any one of the implementation manners 10 to 31 in the first aspect of the present invention, and a dielectric reflection surface thereof and a director of each antenna unit are separately located on two sides of a main element of a corresponding antenna unit.

Further, the multi-antenna assembly includes two antenna groups which are a first antenna group and a second antenna group, and a size of a main element of an antenna unit of the former is larger than a size of a main element of an antenna unit of the latter.

Further, the first antenna group and the second antenna group each include three same antenna units, a dielectric substrate of each antenna unit is vertical to the dielectric reflection surface, the three antenna units of the first antenna group are 120 degrees apart from each other, use a same straight line as an extension intersection line and are equidistant to the extension intersection line, and the three antenna units of the second antenna group are 60 degrees apart from each other and dielectric substrates of the three antenna units intersect to form an equilateral triangle after extending along a surface direction.

Further, the three antenna units of the second antenna group are located at three adjacent spacings of the three antenna units of the first antenna group consecutively.

A fourth aspect of the present invention provides a multi-antenna assembly, including a dielectric reflection board used to reflect radio waves used by the multi-antenna assembly, and at least one antenna group located on a side of the dielectric reflection board, where the antenna group includes at least one antenna unit according to any one of the implementation manners 10 to 31 in the first aspect of the present invention, and the dielectric reflection board and a director of each antenna unit are separately located on two sides of a main element of a corresponding antenna unit.

Further, the multi-antenna assembly includes a first antenna group and a second antenna group that have a same quantity of antenna units, and antenna units of the first antenna group are spaced apart by antenna units of the second antenna group.

Further, the first antenna group and the second antenna group include their respective same antenna units, and their respective antenna units are evenly distributed on the dielectric reflection board in an angular array manner.

Further, the first antenna group and the second antenna group each include three antenna units.

Further, the antenna units of the first antenna group and the antenna units of the second antenna group have similar structures of different sizes.

Further, the multi-antenna assembly includes a reflector with the dielectric reflection surface and at least one antenna unit array disposed on the dielectric reflection surface, the antenna unit array includes two antenna groups which are a first antenna group and a second antenna group, the first antenna group includes multiple first antenna units with a first operating band, the second antenna group includes at least one second antenna unit with a second operating band, the multiple first antenna units form a circle around, and the second antenna unit is located in the circle of the first antenna units.

Further, both the first antenna units and the second antenna unit have a dielectric substrate that is vertically fixed on a side of the same reflection surface, and a main element and a director that are formed on the dielectric substrate.

Further, the number of the first antenna units is three, midperpendicular planes that are of dielectric substrates of the three first antenna units and vertical to the reflection surface converge on a line, and an angle between every two adjacent midperpendicular planes is 120°; and a dielectric substrate of the second antenna unit is vertical to a dielectric substrate of one of the first antenna units.

Further, among medial surfaces of the dielectric substrates of the three first antenna units, a straight-line distance between center points of every two medial surfaces falls within a range of 30-40 mm.

Further, other two dielectric substrates among the dielectric substrates of the three first antenna units are disposed in a mirrored relation to the dielectric substrate of the second antenna unit.

Further, in each first antenna unit and the second antenna unit, a location relationship between the main element and the director is set to: disposing them consecutively along an outer normal direction of the dielectric reflection surface away from the dielectric reflection surface of the reflector.

Further, both the main element and the director are conductors.

Further, the conductors are any one of the following types: a copper conductor, an aluminum conductor, a silver conductor, and an alloy conductor.

Further, the main element and the director are formed of conductors of a same material.

Further, each main element is formed of a first conductor and a second conductor that are spaced apart on a same straight line, and both the directors of the first antenna units and the director of the second antenna unit are formed of at least one linear-shaped conductor; in a same antenna unit, each linear-shaped conductor is parallel to the first conductor and the second conductor in the same antenna unit and located on a same side of a main element in the same antenna unit.

Further, the director of the first antenna unit and the director of the second antenna unit are formed of 2-16 conductors; in the same antenna unit, all linear-shaped conductors are spaced apart along a direction vertical to the first conductor and the second conductor in the same antenna unit.

Further, the number of linear-shaped conductors that form the directors in the first antenna unit is greater than the number of linear-shaped conductors that form the directors in the second antenna unit.

Further, each linear-shaped conductor in the first antenna unit is the same, and a total length of the main element in the first antenna unit is greater than a length of each linear-shaped conductor in the first antenna unit.

Further, a midperpendicular that is of each linear-shaped conductor and vertical to a length direction thereof in the first antenna unit is on a same straight line, and passes through a center location of the total length of the main element in the first antenna unit.

Further, each linear-shaped conductor in the second antenna unit is the same, and a total length of the main element in the second antenna unit is greater than a length of each linear-shaped conductor in the second antenna unit.

Further, a midperpendicular that is of each linear-shaped conductor and vertical to a length direction thereof in the second antenna unit is on a same straight line, and passes through a center location of the total length of the main element in the second antenna unit.

Further, the reflector is a reflection panel, the dielectric reflection surface of the reflection board is a conductor reflection surface, and all antenna unit arrays share one conductor reflection surface.

Further, the antenna is used for a transport system.

Further, the transport system is any one of the following fixed-route transport systems: a metro transport system, a light rail transport system, an air transport system, a marine transport system, an expressway transport system, a submarine tunnel transport system, or a bus transport system.

Further, the first operating band of the first antenna unit and the second operating band of the second antenna unit are mutually different bands selected from 1.8 GHz-12 GHz.

Further, the first operating band or the second operating band is 4.9 GHz-6 GHz.

Further, the first operating band or the second operating band is 5 GHz-5.9 GHz.

Further, the first operating band or the second operating band is 2 GHz-2.6 GHz.

Further, the first operating band or the second operating band is 2.4 GHz-2.5 GHz.

A fifth aspect of the present invention provides a wireless connection device, including an antenna unit according to any one implementation manner of the first aspect of the present invention or an antenna assembly according to any one implementation manner of the second aspect of the present invention or a multi-antenna assembly according to the third aspect and the fourth aspect of the present invention, a feeder corresponding to the antenna unit, and a housing for holding the antenna unit or the antenna assembly or the multi-antenna assembly.

Further, a switch unit for controlling operation of the antenna unit or the antenna group is further included.

The housing includes an upper cover and a bottom cover that are fastened together to form a closed cavity, and includes the multi-antenna assembly located in the cavity.

Further, each antenna group includes at least one antenna unit, and the antenna unit includes a dielectric substrate, a main element used for connecting to a feeder, and a director used to enhance a radio wave on a side where the director is located, where both the main element and the director are conductor wires attached to the dielectric substrate, and the dielectric reflection surface and a director of each antenna unit are separately located on two sides of a main element of a corresponding antenna unit.

Compared with the prior art, the present invention brings the following beneficial effects: because a maximum gain direction is consistent with an extension direction of a surface of a dielectric substrate, high directivity and high long-haul transmission performance are achieved, and a wireless connection device with the multi-antenna assembly can also achieve high data transmission performance.

Compared with the prior art, the present invention further brings the following beneficial effects: an antenna unit, an antenna assembly, and a multi-antenna assembly that are designed according to Yagi antenna principles have high directivity, and have advantages of broad bands, high gains, and easy commissioning.

Compared with the prior art, the present invention further brings the following beneficial effects: the antenna unit and the multi-antenna assembly that are designed according to the Yagi antenna principles satisfy requirements of miniaturizing antennas, and improve coverage effects of a wireless network, and especially, by applying a MIMO technology, satisfy requirements imposed by a new network protocol on antennas.

Compared with the prior art, the present invention further brings the following beneficial effects: (1) in the present invention, midperpendicular planes that are of dielectric substrates of three first antenna units converge on a line, and an angle between every two adjacent midperpendicular planes is 120°; and a dielectric substrate of a second antenna unit is vertical to one of the dielectric substrates of the three first antenna units, which achieves superior overall receiving performance of the antenna of the present invention; (2) when extension planes on two opposite sides of a medial surface in the dielectric substrate of each of the three first antenna units intersect to form a regular triangular prism, and when a mid-plane of the dielectric substrate of the second antenna unit is on one of angle-bisecting planes in the regular triangular prism, the overall receiving performance of the antenna of the present invention is even higher; and (3) further, in a case that the antennas of the present invention are disposed according to (2), when the dielectric substrates of all the first antenna units and the dielectric substrate of the second antenna unit do not physically come in contact with each other directly but are apart from each other by a specific distance, if a distance between center points of medial surfaces of the dielectric substrates of every two adjacent first antenna units is 30-40 mm, the antenna in the present invention is well spaced out.

### BRIEF DESCRIPTION OF DRAWINGS

The following further describes the present invention with reference to accompanying drawings and embodiments:

FIG. 1 is a schematic structural diagram of an antenna unit according to Embodiment 1 of the present invention;

FIG. 2 is a schematic structural diagram of an embodiment of a multi-antenna assembly with an antenna unit shown in FIG. 1 according to Embodiment 1 of the present invention;

FIG. 3 is a schematic structural diagram of another embodiment of a multi-antenna assembly with an antenna unit shown in FIG. 1 according to Embodiment 1 of the present invention;

FIG. 4 is a directivity diagram of the foregoing multi-antenna assembly at a frequency of 2.45 GHz according to Embodiment 1 of the present invention;

FIG. 5 is a directivity diagram of the foregoing multi-antenna assembly at a frequency of 5.72 GHz according to Embodiment 1 of the present invention;

FIG. 6 is a schematic structural diagram of another multi-antenna assembly according to Embodiment 1 of the present invention;

FIG. 7 is a schematic structural diagram of an antenna unit in a multi-antenna assembly shown in FIG. 6 according to Embodiment 1 of the present invention;

FIG. 8 is a schematic structural diagram of an antenna unit according to Embodiment 2 of the present invention;

FIG. 9 is a schematic structural diagram of an antenna assembly with an antenna unit shown in FIG. 8 according to Embodiment 2 of the present invention;

FIG. 10 is a schematic structural diagram of a multi-antenna assembly with at least two antenna groups according to Embodiment 2 of the present invention;

FIG. 11 is a top view of a multi-antenna assembly shown in FIG. 10 according to Embodiment 2 of the present invention;

FIG. 12 is a schematic diagram of a size of an antenna unit of a first antenna group of a multi-antenna assembly shown in FIG. 10 according to Embodiment 2 of the present invention;

FIG. 13 is a schematic diagram of a size of an antenna unit of a second antenna group of a multi-antenna assembly shown in FIG. 10 according to Embodiment 2 of the present invention;

FIG. 14 is an emulation diagram of a low-band voltage standing wave ratio of a multi-antenna assembly shown in FIG. 10 and FIG. 11 according to Embodiment 2 of the present invention;

FIG. 15 is a directivity diagram of the foregoing multi-antenna assembly at a frequency of 2.45 GHz according to Embodiment 2 of the present invention;

FIG. 16 is an emulation diagram of a high-band voltage standing wave ratio of a multi-antenna assembly shown in FIG. 10 and FIG. 11 according to Embodiment 2 of the present invention;

FIG. 17 is a directivity diagram of the foregoing multi-antenna assembly at a frequency of 5.72 GHz according to Embodiment 2 of the present invention;

FIG. 18 is a schematic structural diagram of an implementation manner of an antenna unit according to Embodiment 3 of the present invention;

FIG. 19 is a schematic structural diagram of a multi-antenna assembly with an antenna unit shown in FIG. 18 according to Embodiment 3 of the present invention;

FIG. 20 is a top view of a multi-antenna assembly with at least two antenna groups according to Embodiment 3 of the present invention;

FIG. 21 is a top view of another implementation manner of a multi-antenna assembly with at least two antenna groups according to Embodiment 3 of the present invention;

FIG. 22 is a size diagram of an antenna unit in FIG. 19 according to Embodiment 3 of the present invention;

FIG. 23 is a S11 curve diagram of a multi-antenna assembly shown in FIG. 22 according to Embodiment 3 of the present invention;

FIG. 24 and FIG. 25 are directivity diagrams of the multi-antenna assembly shown in FIG. 22 and operated at a frequency of 2.45 GHz according to Embodiment 3 of the present invention;

FIG. 26 is a 3-dimensional diagram of an embodiment of an antenna (multi-antenna assembly) according to Embodiment 4 of the present invention;

FIG. 27 is a top view of an antenna shown in FIG. 26 according to Embodiment 4 of the present invention;

FIG. 28 is a front view of a first antenna unit in FIG. 26 according to Embodiment 4 of the present invention;

FIG. 29 is a front view of a second antenna unit in FIG. 26 according to Embodiment 4 of the present invention;

FIG. 30 is a structural exploded view of an antenna according to Embodiment 5 of the present invention;

FIG. 31 is a schematic structural diagram of an antenna assembled from those shown in FIG. 30 according to Embodiment 5 of the present invention;

FIG. 32 is a top view of a multi-antenna assembly of the antenna shown in FIG. 30 according to Embodiment 5 of the present invention;

FIG. 33 is a schematic diagram of a size of an antenna unit of a first antenna group of a multi-antenna assembly shown in FIG. 32 according to Embodiment 5 of the present invention;

FIG. 34 is a schematic diagram of a size of an antenna unit of a second antenna group of a multi-antenna assembly shown in FIG. 32 according to Embodiment 5 of the present invention;

FIG. 35 is an emulation diagram of a low-band voltage standing wave ratio of a multi-antenna assembly shown in FIG. 30 and FIG. 31 according to Embodiment 5 of the present invention;

FIG. 36 is a directivity diagram of the foregoing multi-antenna assembly at a frequency of 2.45 GHz according to Embodiment 5 of the present invention;

FIG. 37 is an emulation diagram of a high-band voltage standing wave ratio of a multi-antenna assembly shown in FIG. 30 and FIG. 32 according to Embodiment 5 of the present invention; and

FIG. 38 is a directivity diagram of the foregoing multi-antenna assembly at a frequency of 5.72 GHz according to Embodiment 5 of the present invention.

### DESCRIPTION OF EMBODIMENTS

The following describes embodiments of the present invention in detail with reference to the accompanying drawings. To understand the present invention comprehensively, the following detailed description gives many details. However, persons skilled in the art should understand that the present invention can be implemented without the details. In other implementation manners, detailed description of well-known methods, processes, components and circuits is omitted to avoid unnecessary ambiguity of the embodiments.

### Embodiment 1

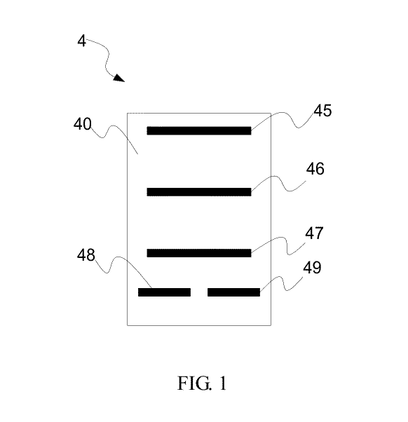

First, Embodiment 1 of the present invention is described in detail with reference to FIG. 1 to FIG. 7.

Embodiment 1 of the present invention relates to an antenna unit, including a dielectric substrate and an antenna conductor attached to the dielectric substrate, where a maximum gain direction of the antenna unit is consistent with an extension direction of a surface of the dielectric substrate. That is, the antenna unit is an end-fire antenna. The end-fire antenna comes in many types. In Embodiment 1 of the present invention, several types of end-fire antennas are described.

The dielectric substrate is made of a material with a dielectric constant less than 10 and a loss angle tangent value less than 0.02, and preferably, a material with a dielectric constant less than 6.5 and a loss angle tangent value less than 0.009. The material may be a pure material or a composite material formed of two or more materials. For example, the dielectric substrate is an epoxy board, a polytetrafluoroethylene board, a Teflon board, a halogen-free board, a Rogers high frequency board or a ceramic board. The dielectric substrate may also be made of a composite material formed of fiber cloth and epoxy cross-linked reaction compounds. In addition, the dielectric substrate is made of a metamaterial board, where the metamaterial board includes a substrate and a microstructure attached to the substrate. Generally, a size of the microstructure is less than half of, or preferably less than a quarter of, or optimally less than one-sixth, of an electromagnetic wave wavelength corresponding to an operating frequency of the antenna unit.

As shown in FIG. 1, an antenna unit 4 in Embodiment 1 of the present invention includes a dielectric substrate 40 and an antenna conductor attached to the dielectric substrate 40, where the antenna conductor includes a main element and a director. The dielectric substrate 40 is made of FR4 and F4b materials, or other substrate materials used by existing antennas.

The main element is used to connect to a feeder, and includes two conductor wires which are a first conductor wire 48 and a second conductor wire 49, where the first conductor wire 48 is electrically connected to an outer conductor of a coaxial feeder cable, and the second conductor wire 49 is electrically connected to a core wire of the coaxial feeder cable. Obviously, the location of the first conductor wire 48 is interchangeable with that of the second conductor wire 49. As shown in FIG. 1, the first conductor wire 48 and the second conductor wire 49 are on the same straight line, and are spaced apart from each other.

The director may be one or more, and is a conductor wire attached to a surface of the dielectric substrate 40. When there are multiple directors, all conductor wires that form the directors are parallel to each other, and located on the same side of the main element, and are used to enhance electromagnetic wave strength on the side of the main element. A specific structure is shown in FIG. 1. A third conductor wire 45, a fourth conductor wire 46, and a fifth conductor wire 47 in FIG. 1 form three directors. The three directors are parallel to each other, and are parallel to the first conductor wire 48 and the second conductor wire 49 that form the main element. Certainly, the directors may be not parallel to each other, and may be not parallel to the main element. The three directors may have the same length or different lengths. For a better effect of directing electromagnetic waves, same-length directors are preferably selected. In addition, the number of directors may be three, or may be two or even one, or more than three. The straight line on which the main element is located is parallel to any one of the foregoing conductor wires, and a total length of the main element is greater than that of any one of the foregoing conductor wires. Preferably, the center of the main element and three center points of the first, second and three conductor wires are on the same straight line.

The first to fifth conductor wires are all made of conductive materials, preferably metal wires such as copper and aluminum.

The director is a radial structure that is formed of a conductor material and disposed along a propagation direction of an electromagnetic wave, and the structure of the director is not limited to the shape of the foregoing parallel conductor wires, and may also be curves or straight lines or curves whose line width is not completely equal. Similarly, the main element may be a straight line or a curve, and a width of the conductor wire of the main element may be homogeneously equal or incompletely equal. The main element may also be a splayed curve ring or a splayed polyline ring, such as a rhombic ring, circular ring, rectangular ring, triangular ring, or polygonal ring that is splayed at any corner. Alternatively, the dielectric substrate includes two surfaces, and at least one director is disposed on another surface that is different from a surface on which the main element is located.

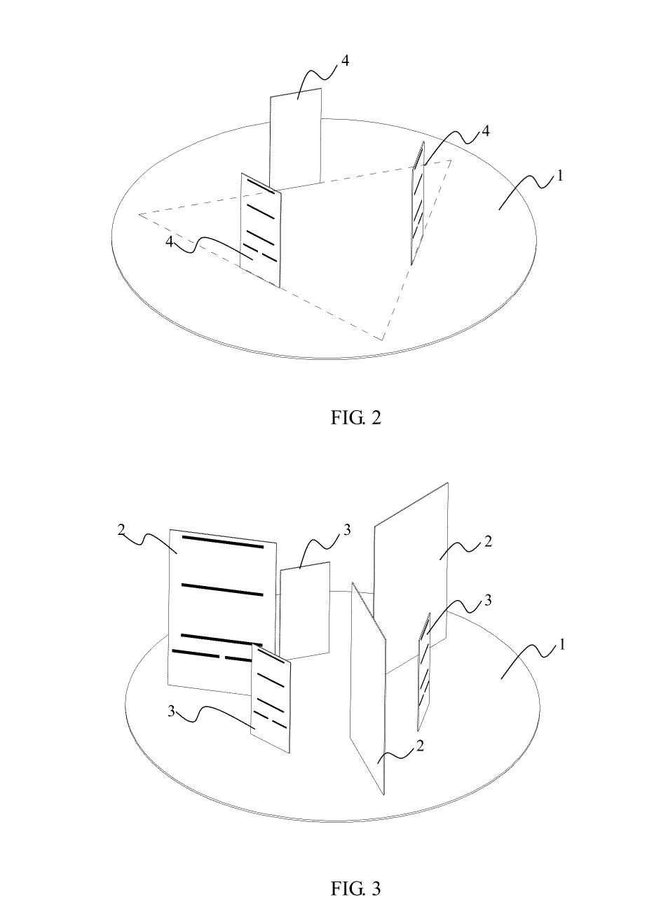

Embodiment 1 of the present invention further protects a multi-antenna assembly, which, as shown in FIG. 2, includes a dielectric reflection surface 1 and an antenna unit 4 disposed on the dielectric reflection surface 1. When there are multiple antenna units 4, and operating frequencies of the antenna units 4 are the same frequency or in the same band, the antenna units form an antenna group.

The dielectric reflection surface 1 is used to reflect radio waves used by any antenna unit 4, and the used radio waves refer to electromagnetic waves generated by each antenna unit or electromagnetic waves received by each antenna unit. In some embodiments, the dielectric reflection surface 1 may be made of copper or other conductive materials, and may be a non-planar surface. It can be understood that the dielectric reflection surface 1 may have discontinuous points, for example, a dielectric surface is processed into a mesh structure or perforated into holes or the like to implement a function of reflecting radio waves, where the size of the mesh structure or the holes is less than one-tenth of the radio wave wavelength used by the multi-antenna assembly. The dielectric reflection surface may also be a conductive microstructure with a geometric pattern, where the conductive microstructure may be any shape so long as it is made of a conductive material, that is, so long as it can reflect radio waves. The size of the conductive microstructure is less than half, or preferably less than a quarter, or optimally less than one-sixth, of a wavelength corresponding to a radio wave frequency used by the antenna group. The conductive microstructure may be arranged regularly or randomly on a baseplate.

The dielectric reflection surface 1 and the directors on each antenna unit 4 are separately located on two sides of the main element of the antenna unit 4. The dielectric reflection surface 1 is a reflector, the first conductor wire 48 and the second conductor wire 49 of the main element form an active element, and the third, fourth and fifth conductor wires form three directors. Because the main element and the directors in the present invention are all in the form of conductor wires instead of metal tubes, the size is much smaller and the structure is more compact, and the antenna also inherits high directivity of Yagi antennas. In addition, multiple antenna units 4 share one dielectric reflection surface 1, which also saves much space and reduces the size of the antenna.

When there are multiple antenna units 4, the multiple antenna units 4 are preferably arranged regularly. The number of antenna units 4 shown in FIG. 2 is three, and the three antenna units 4 are all the same. Therefore, the operating frequencies of the three antenna units 4 are also basically the same, and the three antenna units form an antenna group, which is used to receive and transmit radio waves of this operating frequency.

In FIG. 2, there are three same antenna units 4. A dielectric substrate 40 of each antenna unit 4 is mounted vertically on the dielectric reflection surface 1, the three antenna units are 60 degrees apart from each other, and dielectric substrates 40 of the three antenna units 4 intersect to form an equilateral triangle after extending along a direction of their respective surface.

The three antenna units 4 may also be arranged in another manner, that is, the dielectric substrate 40 of each antenna unit 4 is also mounted vertically on the dielectric reflection surface 1, the three antenna units 4 are 120 degrees apart from each other, the same straight line is used as an extension intersection line of surfaces of any two dielectric substrates, and the three antenna units 4 are equidistant to the extension intersection line.

Certainly, the antenna assembly in the present invention does not necessarily have three antenna units only, but may have only one, two or more than three. The antenna unit is not necessarily arranged by sectioning angles equally, but may be arranged in an array manner or randomly.

When multiple (“multiple” herein refers to two or more) antenna units 4 exist on the dielectric reflection surface 1, and operating frequencies of the multiple antenna units 4 are not completely the same, or in other words, the antenna units 4 are not completely the same which leads to different operating frequencies, different antenna groups are formed according to different operating frequencies. On the dielectric reflection surface 1, at least one antenna group forms an entirety, which is called a multi-antenna assembly.

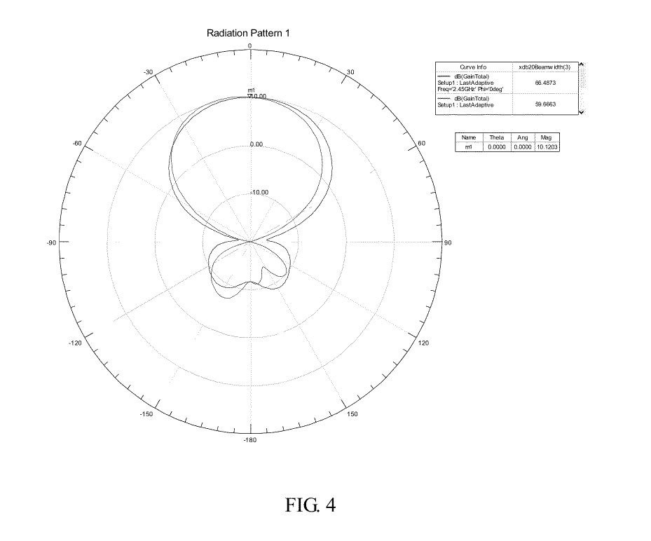

As shown in FIG. 3, the multi-antenna assembly in Embodiment 1 of the present invention has two antenna groups, and each antenna group includes three same antenna units. Hereinafter the antenna unit with a larger size is called a first antenna unit 2, and an antenna group formed of three same first antenna units 2 is called a first antenna group; and the antenna unit with a smaller size is called a second antenna unit 3, and an antenna group formed of three same second antenna units 3 is called a second antenna group. Because the size of the first antenna unit 2 is larger than that of the second antenna unit 3, an operating frequency of an antenna formed of the first antenna unit 2 and the dielectric reflection surface 1 is lower than that of an antenna formed of the second antenna unit and the dielectric reflection surface 1. Therefore, the multi-antenna assembly in this embodiment belongs to a dual-band antenna. Certainly, a main factor that affects the operating frequency herein is the size of the main element. Therefore, even if both the sizes of the dielectric substrates of the first antenna unit 2 and the second antenna unit 3 are the same, so long as the size of the main element of the first antenna unit 2 is larger than that of the main element of the second antenna unit 3, the operating frequency of the former is generally lower than that of the latter.

The dielectric substrate of each antenna unit is vertical to the dielectric reflection surface 1, and is mounted in such a way that the directors and the dielectric reflection surface 1 of the antenna unit are separately located on two sides of the main element of the antenna unit.

As shown in FIG. 3, the three first antenna units 2 are 120 degrees apart from each other, use the same straight line as an extension intersection line of surfaces of the three dielectric substrates, and the three first antenna units 2 are equidistant to the extension intersection line. It may also be construed as that the three first antenna units 2 use the same point as a rotation center, and any first antenna unit rotates 120 degrees around the rotation center to coincide with another first antenna unit 2.

The three second antenna units 3 are arranged in a manner shown in FIG. 2, that is, are 60 degrees apart from each other, and dielectric substrates of the three second antenna units 3 intersect to form an equilateral triangle after extending along a surface direction. A second antenna unit 3 is disposed between every two first antenna units 2, and the two first antenna units 2 are symmetrically located on both sides of the second antenna unit 3 so that the three first antenna units 2 are located at three adjacent spacings of the three second antenna units 3 consecutively. Certainly, each antenna group does not necessarily have three antenna units only, but may have only one, two or more than three. The antenna unit is not necessarily arranged by sectioning angles equally, but may be arranged in an array manner or randomly.

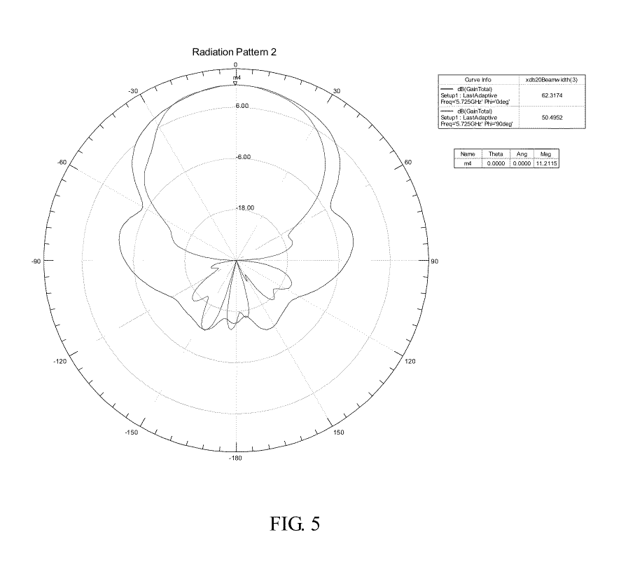

To verify effects of the antenna assembly and the multi-antenna assembly in Embodiment 1 of the present invention, a specific embodiment is given below as an example, in which a dielectric substrate of a first antenna unit 2 is 95 mm long and 50 mm wide, and both a first conductor wire and a second conductor wire are 20 mm long and 1.5 mm wide. The first antenna unit 2 and the second antenna unit 3 have dielectric substrates that are 55 mm long and 25 mm wide, and a first conductor wire and a second conductor wire that are both 9 mm long and 1 mm wide. The dielectric reflection surface 1 is a copper foil. FIG. 4 and FIG. 5 show emulation performed by using the multi-antenna assembly that is of the foregoing size and arranged in a manner shown in FIG. 3. FIG. 4 and FIG. 5 show that the multi-antenna assembly has very good impedance matching in two band ranges: 2.400˜2.4800 GHz and 5.725˜5.8500 GHz.

In conclusion, the antenna unit, the antenna assembly, and the multi-antenna assembly in Embodiment 1 of the present invention have high directivity, belong to dual-band antennas because operating bands are two bands: 2.4 GHz and 5.8 GHz, and have advantages of broad bands, high gains, and easy commissioning. Obviously, when the multi-antenna assembly in the present invention has three or more antenna groups, a multi-band antenna can be obtained, which also falls within the protection scope of the present invention.

In addition, it should be noted that the antenna group in this embodiment is directly mounted on the dielectric reflection surface, and therefore, the dielectric reflection surface is equivalent to a mounting baseplate. Obviously, the antenna group may be relatively fixed by using another mounting structure before being connected to the dielectric reflection surface or even not being connected to the dielectric reflection surface. The dielectric reflection surface is merely used for reflecting electromagnetic waves transmitted and received by the antenna unit of the antenna group, and does not necessarily serve a purpose of mounting. Therefore, the antenna assembly and the multi-antenna assembly in the present invention fall within the protection scope of the present invention so long as the dielectric reflection surface is located on the side of the antenna unit.

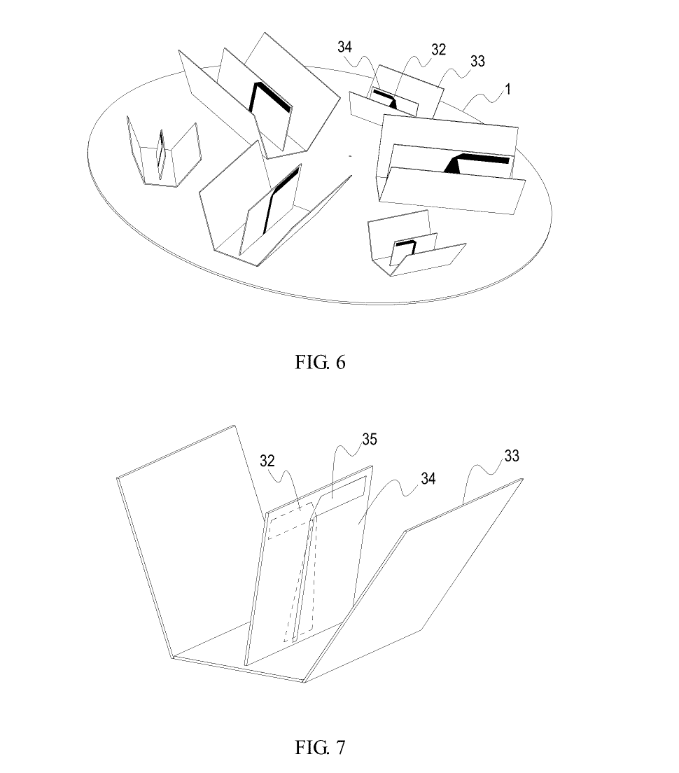

The antenna conductor may also be in another structure, and the antenna conductor may include a first antenna conductor disposed on one surface of the dielectric substrate and a second antenna conductor that is disposed on another surface. For example, in the multi-antenna assembly shown in FIG. 6 and FIG. 7 and antenna units of the multi-antenna assembly, each antenna unit includes a dielectric substrate 34, a first antenna conductor 32 attached to a surface on one side of the dielectric substrate 34 and a second antenna conductor 35 attached to a surface on the other side of dielectric substrate 34. Both antenna conductors are similar to L shapes, and the L shapes are opposite to each other. Each antenna unit is encircled by a reflector 33. The reflector 33 is a splayed structure that is small at one end and big at the other end, and the splay is oriented to a maximum gain direction of the encircled antenna unit.

Certainly, the antenna unit in the present invention may be in other structures, which fall within the protection scope of the present invention so long as the maximum gain direction of the antenna unit extends along the surface direction of the dielectric substrate. That the maximum gain direction of the antenna unit is consistent with the extension direction of the surface of the dielectric substrate herein includes a scenario in which the maximum gain direction and the surface of the dielectric substrate form a specific small angle. For example, when an angle less than 45 degrees is formed between the two, the maximum gain direction of the antenna unit is also considered consistent with the extension direction of the surface of the dielectric substrate.

When the antenna unit includes multiple layers of dielectric substrates, the antenna conductor may be disposed on one or more of the multiple layers of dielectric substrates.

Embodiment 1 of the present invention also relates to a wireless connection device, which includes a housing with an inner cavity, and the foregoing antenna unit or the foregoing multi-antenna assembly that is placed in the cavity, and further includes a feeder that is correspondingly connected to the antenna unit or to the antenna unit of the multi-antenna assembly. The wireless connection device may be a wireless device, such as a wife ceiling antenna, a wireless router, or a television set-top-box.

Because a maximum gain direction is consistent with an extension direction of a surface of a dielectric substrate, the antenna unit and the multi-antenna assembly in Embodiment 1 of the present invention achieve high directivity and high long-haul transmission performance, and a wireless connection device with the multi-antenna assembly can also achieve high data transmission performance.

### Embodiment 2

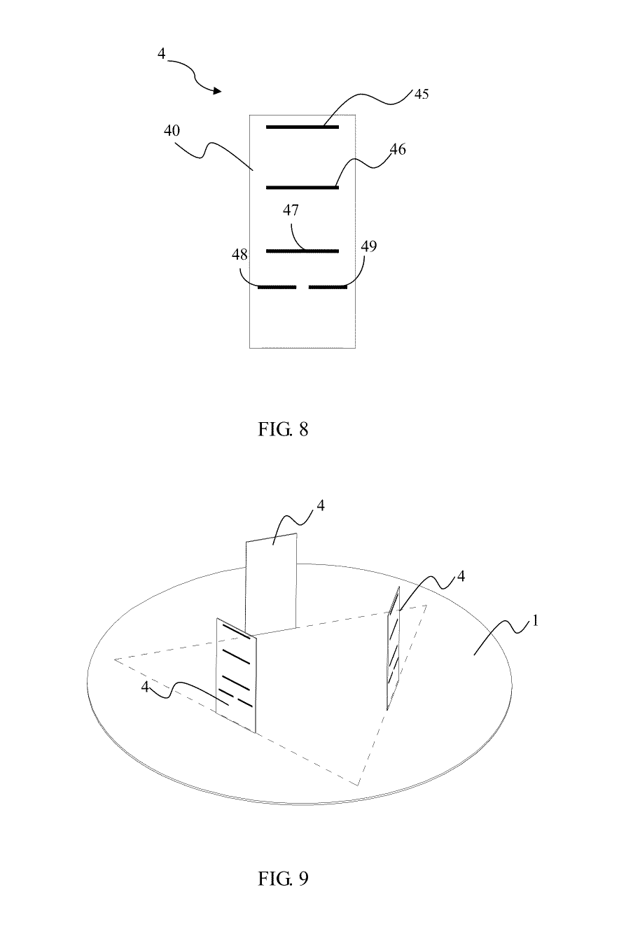

The following describes Embodiment 2 in detail with reference to FIG. 8 to FIG. 17.

As shown in FIG. 8, an antenna unit 4 in Embodiment 2 of the present invention includes a dielectric substrate 40, and a main element and a director that are attached to the dielectric substrate 40. The dielectric substrate 40 is made of FR4 and F4b materials, or other substrate materials used by existing antennas.

The main element is used to connect to a feeder, and includes two conductor wires which are a first conductor wire 48 and a second conductor wire 49, where the first conductor wire 48 is electrically connected to an outer conductor of a coaxial feeder cable, and the second conductor wire 49 is electrically connected to a core wire of the coaxial feeder cable. Obviously, the location of the first conductor wire 48 is interchangeable with that of the second conductor wire 49.

As shown in FIG. 8, the first conductor wire 48 and the second conductor wire 49 are on the same straight line, and are spaced apart from each other.

The director may be one or more, and is a conductor wire attached to a surface of the dielectric substrate 40. When there are multiple directors, all conductor wires that form the directors are parallel to each other, and located on the same side of the main element, and are used to enhance electromagnetic wave strength on this side of the main element. A specific structure is shown in FIG. 8. A third conductor wire 45, a fourth conductor wire 46, and a fifth conductor wire 47 in FIG. 8 form three directors. The three directors are arranged parallel to each other, and are parallel to the first conductor wire 48 and the second conductor wire 49 that form the main element. The three directors may have the same length or different lengths. For a better effect of directing electromagnetic waves, same-length directors are preferably selected. In addition, the number of directors may be three, or may be two or even one, or more than three. Generally, if there are more than five directors, impact on an electromagnetic field changes scarcely. In order to save space and materials, and three directors are preferably used.

Preferably, three center points of the third, fourth and fifth conductors 45, 46 and 47 are on one straight line, and the straight line is vertical to any of the three conductor wires. In addition, the straight line on which the main element is located is parallel to any one of the foregoing conductor wires, and a total length of the main element is greater than that of any one of the foregoing conductor wires. Preferably, the center of the main element and three center points of the first, second and three conductor wires are on the same straight line.

The first to fifth conductor wires are all made of conductive materials, preferably metal wires such as copper and aluminum.

The antenna unit with such a structure can form a structure similar to a Yagi antenna after a reflector is mounted on the other side of the main element. A Yagi antenna, also called a Yagi-Uda antenna, is generally in a shape of “ [symbol] ”. A main element (also called an active element) is located at the center of the “ [symbol] ”, and is connected to a feeder. A reflector is located on a side of the main element to serve a purpose of weakening electromagnetic waves on this side, and is a little longer than the main element. A director is located on the other side of the main element, and is a little shorter than the main element and is used to enhance electromagnetic waves on this side.

The Yagi antenna has advantages of high directivity, and is highly effective in direction finding and long-haul communication. However, existing Yagi antennas, which are all made of metal rods, are large in size, occupy much space, and are primarily used outdoors. How to apply advantages of the Yagi antenna to wireless-coverage small antennas such as a ceiling antenna and a wireless router is an issue that the present invention intends to solve.

Therefore, Embodiment 2 of the present invention further protects an antenna assembly, which, as shown in FIG. 9, includes a dielectric reflection surface 1 and an antenna unit 4 disposed on the dielectric reflection surface 1. When there are multiple antenna units 4, and operating frequencies of the antenna units 4 are the same frequency or in the same band, the antenna units form an antenna group.

The dielectric reflection surface 1 is used to reflect radio waves used by any antenna unit 4, and the used radio waves refer to electromagnetic waves generated by each antenna unit or electromagnetic waves received by each antenna unit. In some embodiments, the dielectric reflection surface 1 may be made of copper or other conductive materials, and may be a non-planar surface. It can be understood that the dielectric reflection surface 1 may have discontinuous points, for example, a dielectric surface is processed into a mesh structure or perforated into holes or the like to implement a function of reflecting radio waves, where the size of the mesh structure or the holes is less than one-tenth of the radio wave wavelength used by the multi-antenna assembly.

The dielectric reflection surface 1 and the directors on each antenna unit 4 are separately located on two sides of the main element of the antenna unit 4, and form a miniature Yagi antenna as a whole. The dielectric reflection surface 1 is a reflector, the first conductor wire 48 and the second conductor wire 49 of the main element form an active element, and the third, fourth and fifth conductor wires form three directors. Because the main element and the directors in the present invention are all in the form of conductor wires instead of metal tubes, the size is much smaller and the structure is more compact, and the antenna has high directivity of Yagi antennas. In addition, multiple antenna units 4 share one dielectric reflection surface 1, which also saves much space and reduces the size of the antenna.

When there are multiple antenna units 4, the multiple antenna units 4 are preferably arranged regularly. The number of antenna units 4 shown in FIG. 9 is three, and the three antenna units 4 are all the same. That is, they have the same substrate material and substrate size, and the material, size, and location of their main element and directors are the same. Therefore, the operating frequencies of the three antenna units 4 are also basically the same, and the three antenna units form an antenna group, which is used to receive and transmit radio waves of this operating frequency.

In FIG. 9, there are three same antenna units 4. A dielectric substrate 40 of each antenna unit 4 is mounted vertically on the dielectric reflection surface 1, the three antenna units are 60 degrees apart from each other, and dielectric substrates 40 of the three antenna units 4 intersect to form an equilateral triangle after extending along a direction of their respective surface.

The three antenna units 4 may also be arranged in another manner, that is, the dielectric substrate 40 of each antenna unit 4 is also mounted vertically on the dielectric reflection surface 1, the three antenna units 4 are 120 degrees apart from each other, the same straight line is used as an extension intersection line of surfaces of any two dielectric substrates, and the three antenna units 4 are equidistant to the extension intersection line.

Certainly, the antenna assembly in the present invention does not necessarily have three antenna units only, but may have only one, two or more than three. The antenna unit is not necessarily arranged by sectioning angles equally, but may be arranged in an array manner or randomly.

When multiple (“multiple” herein refers to two or more) antenna units 4 exist on the dielectric reflection surface 1, and operating frequencies of the multiple antenna units 4 are not completely the same, or in other words, the antenna units 4 are not completely the same which leads to different operating frequencies, different antenna groups are formed according to different operating frequencies. On the dielectric reflection surface 1, multiple antenna groups form an entirety, which is called a multi-antenna assembly.

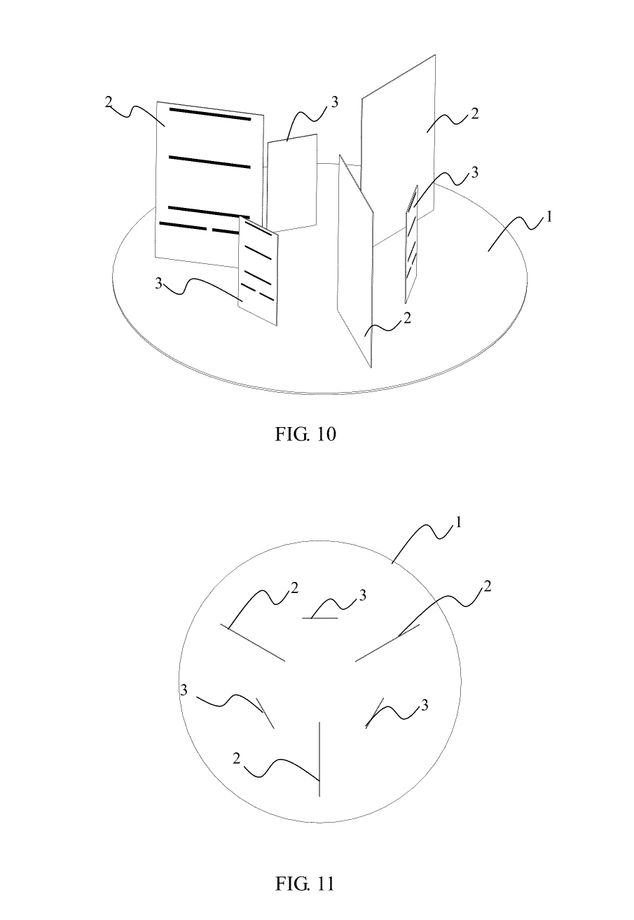

As shown in FIG. 10 and FIG. 11, the multi-antenna assembly in the present invention has two antenna groups, and each antenna group includes three same antenna units. Hereinafter the antenna unit with a larger size is called a first antenna unit 2, and an antenna group formed of three same first antenna units 2 is called a first antenna group; and the antenna unit with a smaller size is called a second antenna unit 3, and an antenna group formed of three same second antenna units 3 is called a second antenna group. Because the size of the first antenna unit 2 is larger than that of the second antenna unit 3, an operating frequency of an antenna formed of the first antenna unit 2 and the dielectric reflection surface 1 is lower than that of an antenna formed of the second antenna unit and the dielectric reflection surface 1. Therefore, the multi-antenna assembly in this embodiment belongs to a dual-band antenna. Certainly, a main factor that affects the operating frequency herein is the size of the main element. Therefore, even if both the sizes of the dielectric substrates of the first antenna unit 2 and the second antenna unit 3 are the same, so long as the size of the main element of the first antenna unit 2 is larger than that of the main element of the second antenna unit 3, the operating frequency of the former is generally lower than that of the latter.

The dielectric substrate of each antenna unit is vertical to the dielectric reflection surface 1, and is mounted in such a way that the directors and the dielectric reflection surface 1 of the antenna unit are separately located on two sides of the main element of the antenna unit.

As shown in FIG. 11, the three first antenna units 2 are 120 degrees apart from each other, use the same straight line as an extension intersection line of surfaces of the three dielectric substrates, and the three first antenna units 2 are equidistant to the extension intersection line. It may also be construed as that, as seen from the top view shown in FIG. 11, the three first antenna units 2 use the same point as a rotation center, and any first antenna unit rotates 120 degrees around the rotation center to coincide with another first antenna unit 2.

The three second antenna units 3 are arranged in a manner shown in FIG. 9, that is, are 60 degrees apart from each other, and dielectric substrates of the three second antenna units 3 intersect to form an equilateral triangle after extending along a surface direction. In addition, as shown in FIG. 11, a second antenna unit 3 is disposed between every two first antenna units 2, and the two first antenna units 2 are symmetrically located on both sides of the second antenna unit 3, so that the three first antenna units 2 are located at three adjacent spacings of the three second antenna units 3 consecutively.

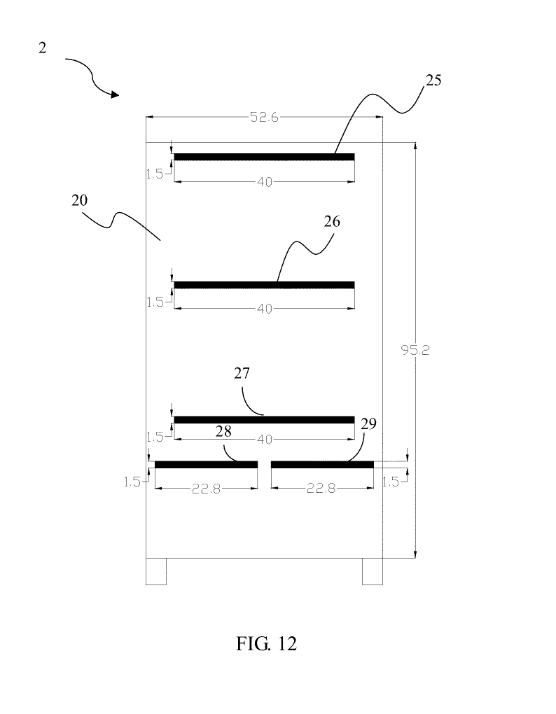

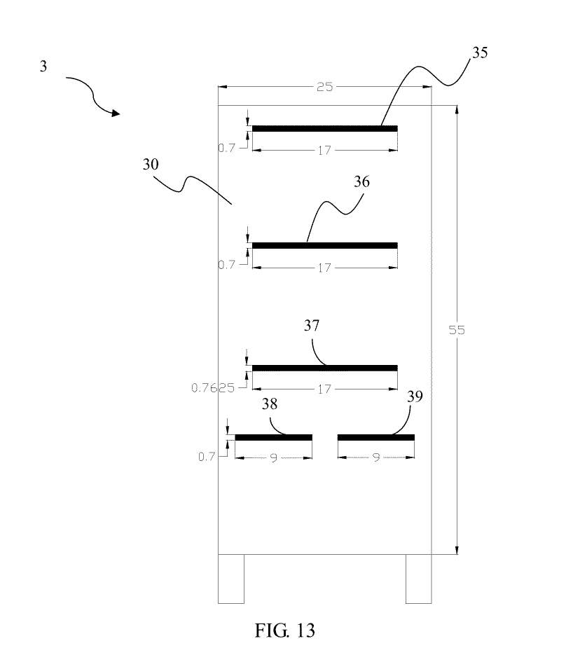

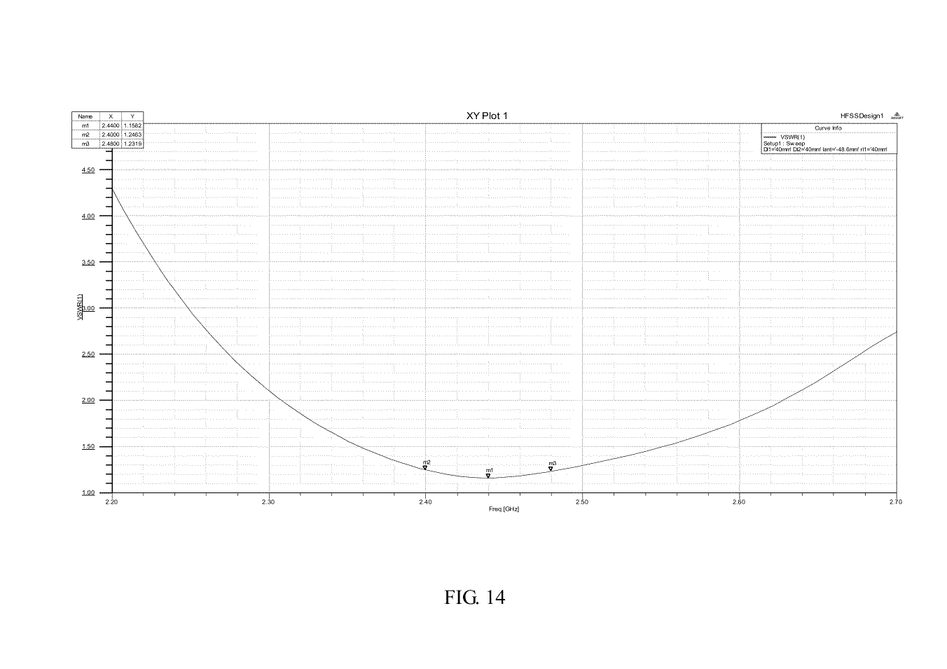

To verify effects of the antenna assembly and the multi-antenna assembly in Embodiment 2 of the present invention, a specific embodiment is given as an example, in which sizes of a first antenna unit 2 and a second antenna unit 3 are shown in FIG. 12 and FIG. 13, a dielectric substrate 20 of the first antenna unit 2 is 95.2 mm long and 52.6 mm wide, both a first conductor wire 28 and a second conductor wire 29 are 22.8 mm long and 1.5 mm wide, and a third conductor wire 25, a fourth conductor wire 26 and a fifth conductor wire 27 are all 40 mm long and 1.5 mm wide. The first antenna unit 2 and the second antenna unit 3 have dielectric substrates 20 that are 55 mm long and 25 mm wide, a first conductor wire 38 and a second conductor wire 39 that are both 9 mm long and 0.7 mm wide, and a third conductor wire 35, a fourth conductor wire 36 and a fifth conductor wire 37 that are all 17 mm long and 0.7 mm wide. The dielectric reflection surface 1 is a copper foil with a diameter of 200 mm. FIG. 14 to FIG. 17 show emulation performed by using the multi-antenna assembly that is of the foregoing size and arranged in a manner shown in FIG. 10 and FIG. 11.

FIG. 14 is a low-band standing wave ratio emulation diagram. Three points m1, m2, and m3 marked in FIG. 14 have the following coordinate parameters in the emulation diagram:

| Name | X (GHz) | Y |
|---|---|---|
| m1 | 2.4400 | 1.1582 |
| m2 | 2.4000 | 1.2463 |
| m3 | 2.4800 | 1.2319 |

The foregoing table shows that the multi-antenna assembly has very good impedance matching in a band range of 2.400˜2.4800 GHz.

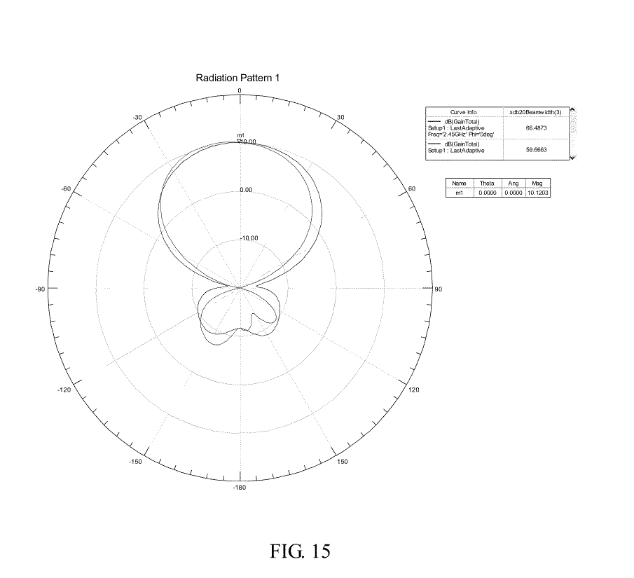

FIG. 15 is a directivity diagram of the foregoing multi-antenna assembly in an electromagnetic field with a frequency of 2.45 GHz. As shown in the figure, emission at this frequency has high directivity, which can satisfy radio signal receive and transmit requirements.

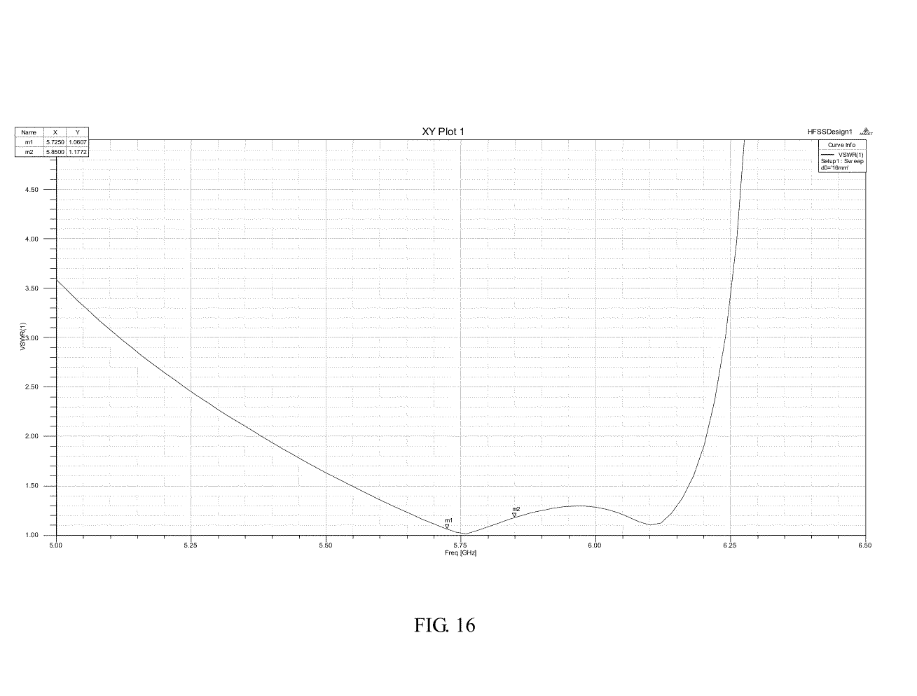

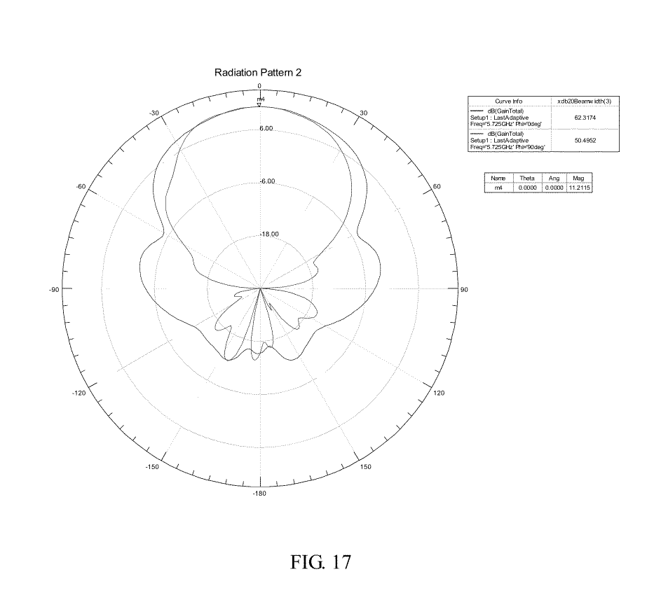

FIG. 16 is a high-band standing wave ratio emulation diagram. Two points m1 and m2 marked in FIG. 16 have the following coordinate parameters in the emulation diagram:

| Name | X (GHz) | Y |
|---|---|---|
| m1 | 5.7250 | 1.0607 |
| m2 | 5.8500 | 1.1772 |

The foregoing table shows that the multi-antenna assembly has very good impedance matching in a band range of 5.725˜5.8500 GHz.

FIG. 17 is a directivity diagram of the foregoing multi-antenna assembly in an electromagnetic field with a frequency of 5.725 GHz. As shown in the figure, emission at this frequency has high directivity, which can satisfy radio signal receiving and transmitting requirements.

In conclusion, the antenna unit, antenna assembly, and multi-antenna assembly designed according to Yagi antenna principles have high directivity, belong to dual-band antennas because operating bands are two bands: 2.4 GHz and 5.8 GHz, and have advantages of broad bands, high gains, and easy commissioning. Obviously, when the multi-antenna assembly in the present invention has three or more antenna groups, a multi-band antenna can be obtained, which also falls within the protection scope of the present invention.

In addition, it should be noted that the antenna group in this embodiment is directly mounted on the dielectric reflection surface, and therefore, the dielectric reflection surface is equivalent to a mounting baseplate. Obviously, the antenna group may be relatively fixed by using another mounting structure before being connected to the dielectric reflection surface or even not being connected to the dielectric reflection surface. The dielectric reflection surface is merely used for reflecting electromagnetic waves transmitted and received by the antenna unit of the antenna group, and does not necessarily serve a purpose of mounting. Therefore, the antenna assembly and the multi-antenna assembly in the present invention fall within the protection scope of the present invention so long as the dielectric reflection surface is located on the side of the antenna unit.

### Embodiment 3

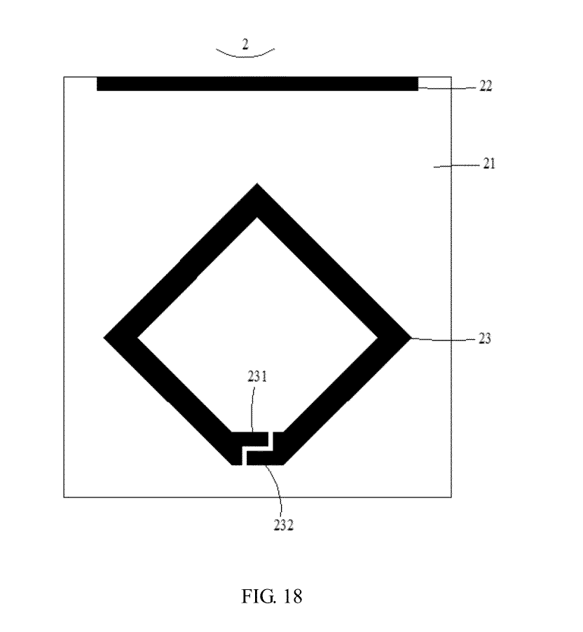

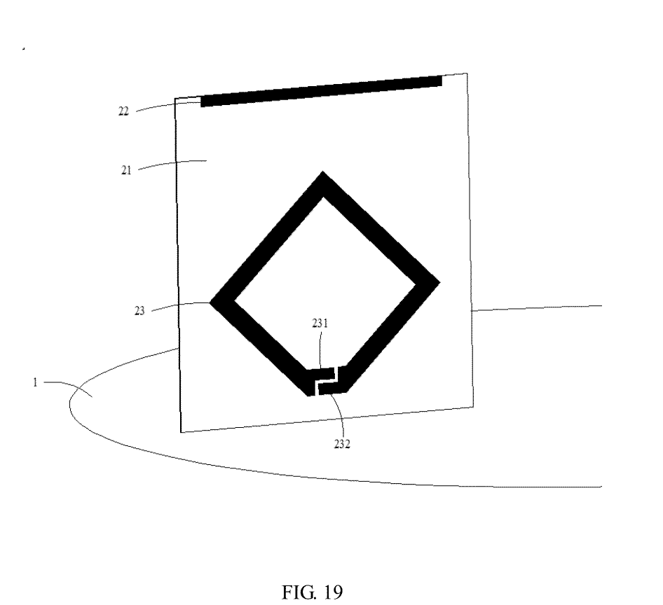

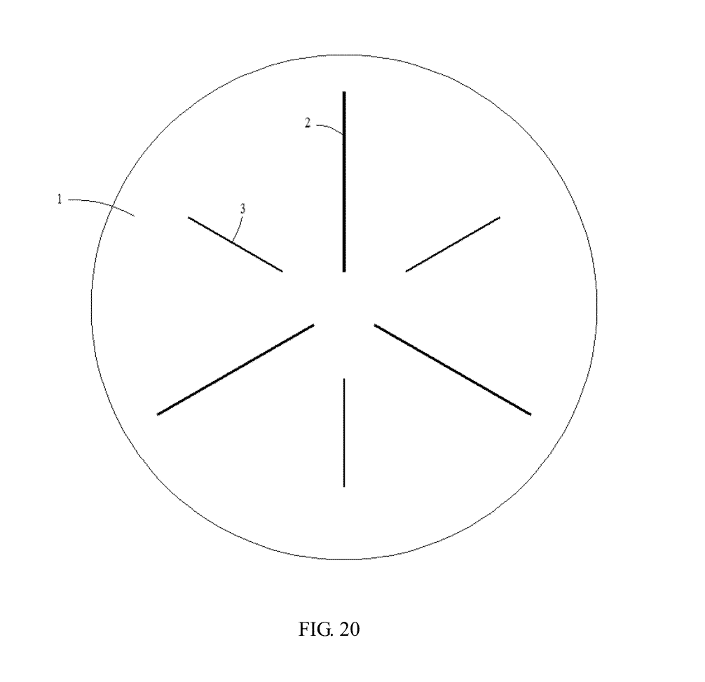

The following describes Embodiment 3 of the present invention in detail with reference to FIG. 18 to FIG. 25.

FIG. 18 is a schematic structural diagram of an implementation manner of an antenna unit according to Embodiment 3 of the present invention. The antenna unit 2 includes a dielectric substrate 21 and a director 22 and an element 23 (corresponding to a main element) that are attached to the dielectric substrate 21. The dielectric substrate 21 is made of FR4 and F4b materials, or other substrate materials used by existing antennas. The dielectric substrate 21 includes two surfaces, and both the director 22 and the element 23 are disposed on the same surface of the dielectric substrate 21.

Both the director 22 and the element 23 are conductor strips. The number of directors 22 may be three, or may be two or even one, or more than three. In this embodiment, only one director is disposed. In other implementation manners, multiple directors may be disposed. Conductor strips that form the directors are arranged on the dielectric substrate in parallel. The conductor strips are spaced apart. To achieve better effects of directing electromagnetic waves, lengths are preferably equal. If there are more than five directors, impact on an electromagnetic field changes scarcely, and three directors are preferably used. In order to save space and materials, one director is used in this embodiment. In this embodiment, the director 22 uses straight conductor strips, or may use curved conductor strips, where curved conductor strips with a relatively large radian or wavy conductor strips are preferably used.

The element 23 is a splay rhombic shape. The splay is disposed at a corner of a rhombic backward director 22. Some conductor strips at the splay have some overlaps distributed vertically. The overlaps are spaced apart to form a splay. The conductor strips with the overlaps form two L-shaped structures. Two relatively long edges of the two L-shaped structures are opposite to each other, and two relatively short edges are on both sides of the relatively long edges separately. A feed point 231 and a ground point 232 are disposed on the two relatively long edges of the L shape separately. Preferably, the feed point 231 is disposed on a relatively long edge of an upper L shape, and the ground point 232 is disposed on a relatively long edge of a lower L shape, which facilitates implementation of vertical feeding to the antenna.

The element 23 may be a splay curve ring or a splay polyline ring. The splay curve ring may be a splay oval ring, a splay spliced hyperbolic or parabolic ring, a splay wavy ring, and the like. The splay polyline ring includes various splay polygonal rings with equal sides, splay irregular polygonal rings, and the like.

In this embodiment, the director 22 and the element 23 are disposed on the same surface of the dielectric substrate 21, and the director 22 may also be disposed on a surface that is different from the dielectric substrate 21 surface on which the element 23 is located. When there are multiple directors 22, at least one director may be disposed on the surface that is different from the dielectric substrate 21 surface on which the element 23 is located.

The conductor strips of the director 22 and the element 23 may be made of a material that is a metal, a conductive nonmetal, and a compound of a metal and a nonmetal, where the metal may be aluminum, copper, silver, or the like, or may be an alloy of several metals, and the nonmetal is preferably conductive ink.

FIG. 19 is a schematic structural diagram of an implementation manner of a multi-antenna assembly according to Embodiment 3 of the present invention. In this implementation manner, the multi-antenna assembly includes an antenna group and a dielectric reflection board 1, where the antenna group includes only one antenna unit 2 and therefore details are not described. The dielectric reflection board 1 is generally a copper-coated board, and in some implementation manners, is a dielectric substrate with a metal grid.

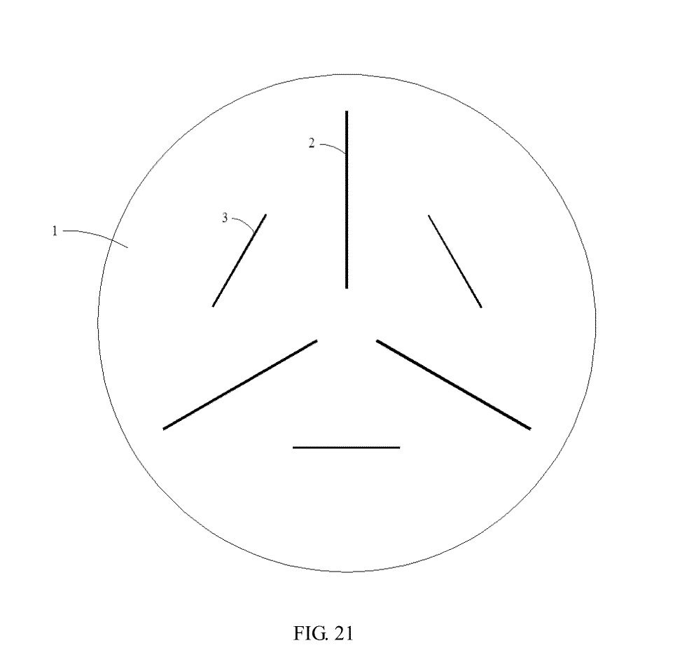

FIG. 20 and FIG. 21 are top views of other implementation manners of a multi-antenna assembly. In the two implementation manners, the multi-antenna assembly includes two antenna groups, and each antenna group includes three antenna units 2 and three antenna units 3, where the antenna units 2 and the antenna units 3 may be antenna units with the same structure but different sizes, thereby bringing an effect of emitting electromagnetic waves of different bands. The antenna units 2 and the antenna units 3 of two antenna groups in FIG. 20 and FIG. 21 are evenly distributed on the dielectric reflection board in an angular array manner. Each antenna unit 2 is located between two antenna units 3, and in FIG. 21, the antenna unit 2 and the antenna unit 3 are disposed in different manners.

Certainly, the multi-antenna assembly in the present invention may include one or more antenna units. The antenna unit is not necessarily arranged by sectioning angles equally, but may be arranged in a straight line manner or in an array manner or randomly.

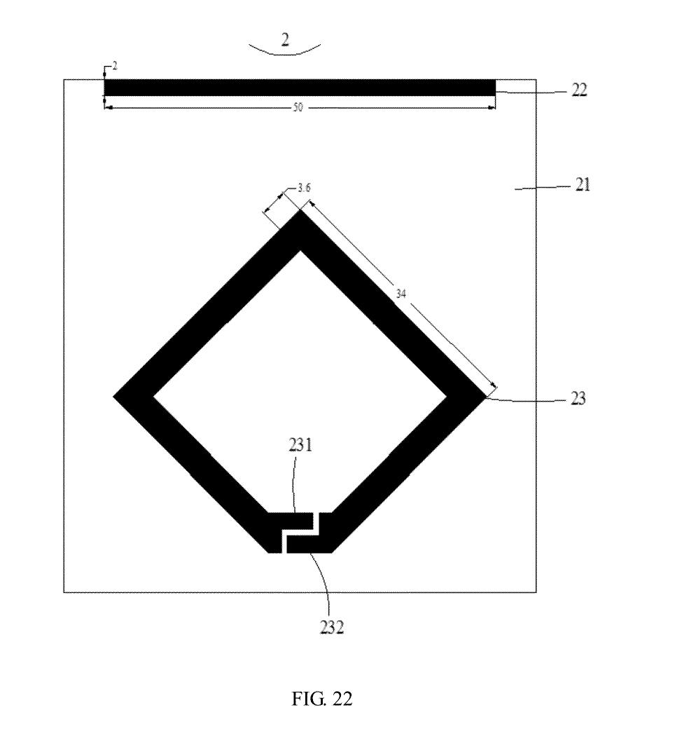

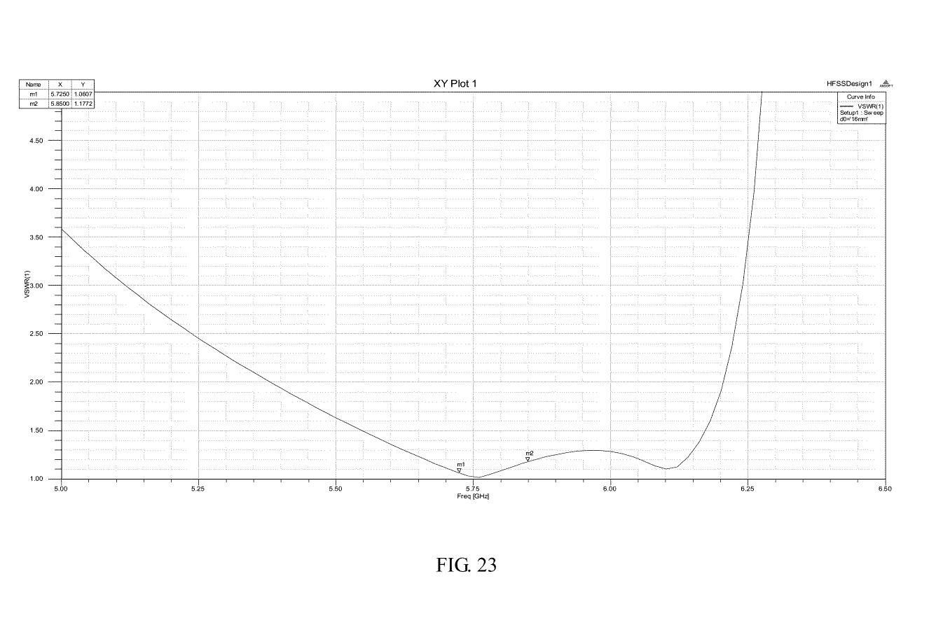

FIG. 22 is a size diagram of an antenna unit 2 in FIG. 19, where the director 22 is 50 mm×2 mm, an outer side length of a splay rhombic ring is 34 mm, and a side width is 3.6 mm, and emulation is performed after arrangement is performed according to FIG. 19.

FIG. 23 is an S11 parameter diagram. Three points m1, m2, and m3 marked in FIG. 23 have the following coordinate parameters in the emulation diagram:

| Name | X (GHz) | Y |
|---|---|---|
| m1 | 2.3994 | 10.05 |
| m2 | 2.4955 | 10.001 |
| m3 | 2.4428 | 21.322 |

The foregoing table shows that the multi-antenna assembly in Embodiment 3 has very good impedance matching in a band range of 2.399˜2.4955 GHz.

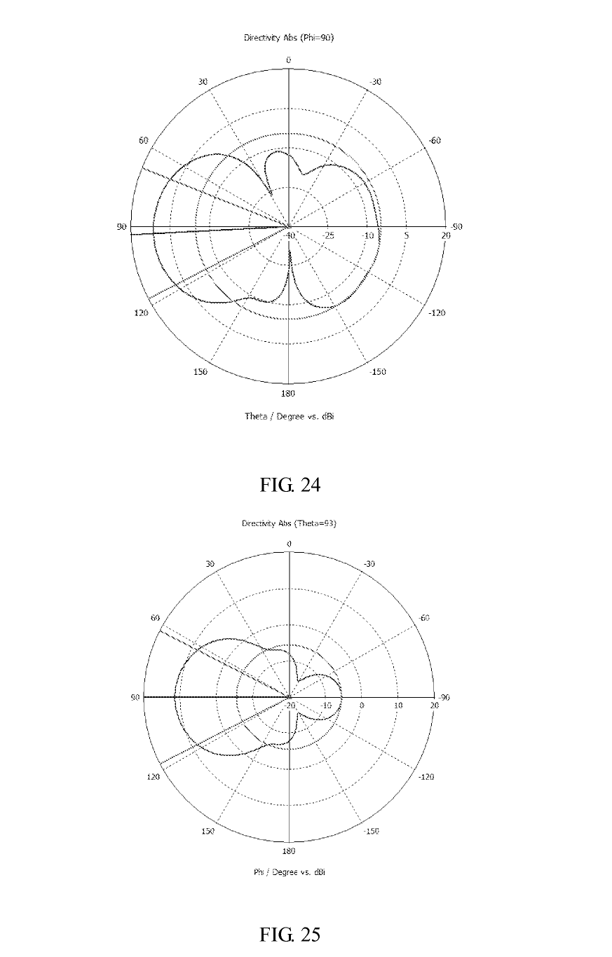

FIG. 24 and FIG. 25 are directivity diagrams of the foregoing multi-antenna assembly in an electromagnetic field with a frequency of 2.4 GHz. As shown in the figures, emission at this frequency has high directivity, which can satisfy radio signal receiving and transmitting requirements.

In addition, it should be noted that the antenna group in Embodiment 3 is directly mounted on the dielectric reflection board, and therefore, the dielectric reflection board is equivalent to a mounting baseplate. Obviously, the antenna group may be relatively fixed by using another mounting structure before being connected to the dielectric reflection surface or even not being connected to the dielectric reflection surface. The dielectric reflection board is merely used for reflecting electromagnetic waves transmitted and received by the antenna unit of the antenna group, and does not necessarily serve a purpose of mounting. Therefore, the antenna assembly and the multi-antenna assembly in the present invention fall within the protection scope of the present invention so long as the dielectric reflection board is located on the side of the antenna unit.

### Embodiment 4

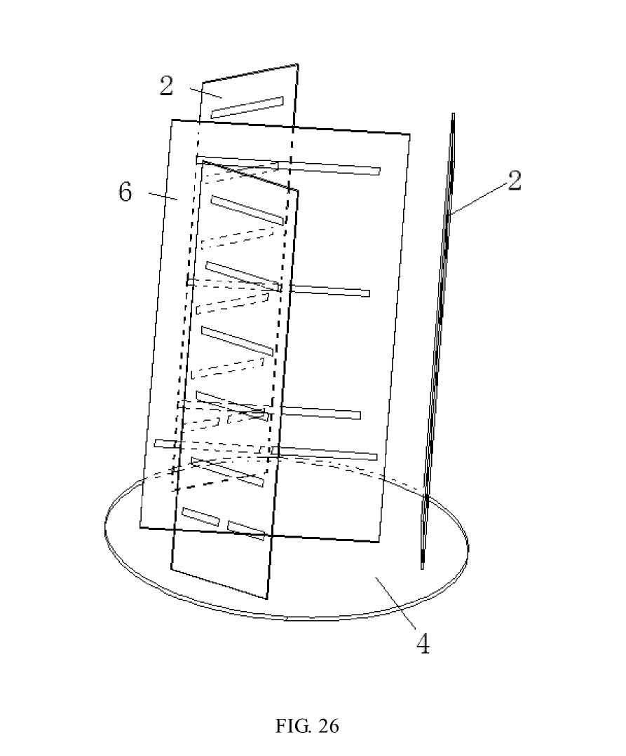

The following describes Embodiment 4 of the present invention with reference to FIG. 26 to FIG. 29.

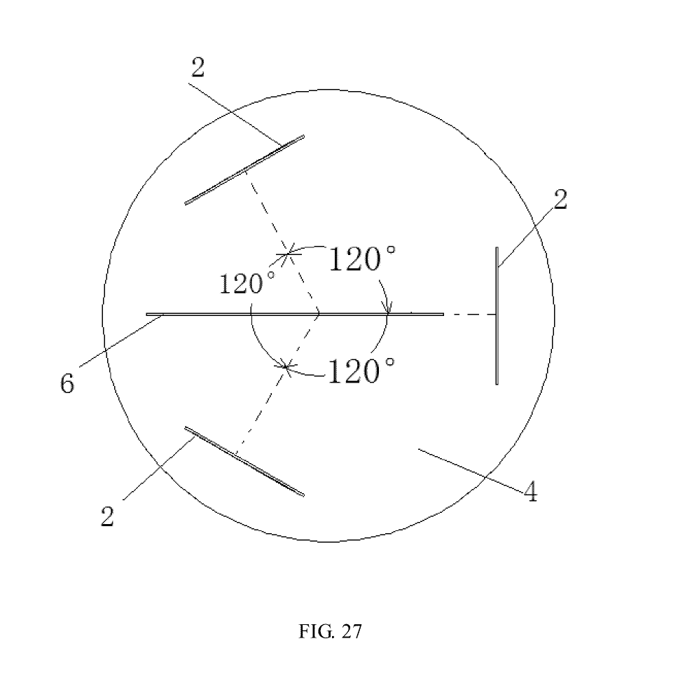

With reference to an embodiment of Embodiment 4 of the present invention shown in FIG. 26 to FIG. 27, an antenna (corresponding to a multi-antenna assembly) in Embodiment 4 of the present invention includes: a reflector 4 and at least one antenna unit array (which is one antenna unit array in this embodiment). All antenna unit arrays are disposed on a reflection surface side of the reflector 4. If two opposite surfaces of the reflector are both reflection surfaces, the antenna unit array, which serves as a minimum unit, may be disposed on either of the two reflection surface sides.

As shown in FIG. 26, the antenna unit array includes multiple first antenna units 2 with a first operating band, and at least one second antenna unit 6 with a second operating band, where the multiple first antenna units 2 form a circle around, and the second antenna unit 6 is located in the circle of the first antenna units 2. In this embodiment, each antenna unit array is formed of three first antenna units 2 with the first operating band, and a second antenna unit 6 with the second operating band. The second operating band is less than the first operating band. The first operating band or the second operating band may be 4.9 GHz-6 GHz; the first operating band or the second operating band may be 5 GHz-5.9 GHz; the first operating band or the second operating band may be 2 GHz-2.6 GHz; and the first operating band or the second operating band may be 2.4 GHz-2.5 GHz.

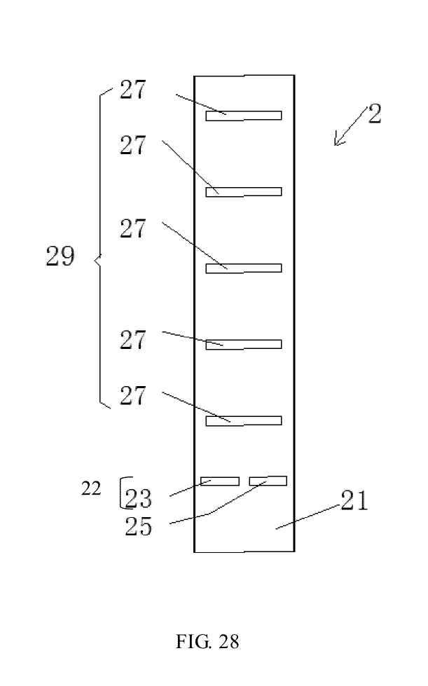

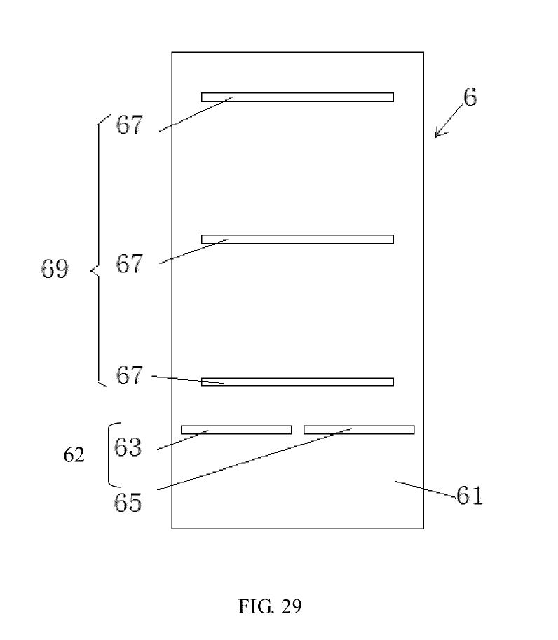

With reference to FIG. 26 and FIG. 27, it can be seen that each first antenna unit 2 is formed of a dielectric substrate 21 that is vertically fixed on a reflection surface side of the reflector 4, and a main element 22 and a director 29 (shown in FIG. 28) that are formed on the dielectric substrate 21. Similarly, the second antenna unit 6 is formed of a dielectric substrate 61 that is vertically fixed on a reflection surface side of the reflector 4, and a main element 62 and a director 69 (shown in FIG. 29) that are formed on the dielectric substrate 61.

Further, FIG. 27 shows a location relationship between dielectric substrates 21 of the three first antenna units: each of the three dielectric substrates 21 has a midperpendicular plane vertical to the reflection surface, and therefore, the three midperpendicular planes of the three dielectric substrates 21 converge on a line. In this case, an angle between every two adjacent midperpendicular planes is 120°; and a dielectric substrate 61 of the second antenna unit 6 is arranged as being vertical to one of the dielectric substrates 21 of three first antenna units.

As an exemplary manner, as shown in FIG. 27, two other dielectric substrates (except the dielectric substrate vertical to the dielectric substrate 61 of the second antenna unit 6) among the dielectric substrates 21 of the three first antenna units 2 are disposed in a mirrored relation to the dielectric substrate 61 of the second antenna unit 6.

Also referring to FIG. 27, as mentioned above, the three dielectric substrates 21 spaced apart with 120° apart from each other are spaced apart from the dielectric substrate 61 vertical to one of the dielectric substrates 21. For example, also referring to FIG. 27, projections of the dielectric substrates 21 of the three first antenna units 2 onto a reflection surface of the reflector 4 are spaced apart from that of the dielectric substrate 61 of the second antenna unit 6.

Further, in order to describe a best manner of an antenna unit array in an antenna according to Embodiment 4 of the present invention from a perspective of a regular triangular prism, the following is defined first. That is, each dielectric substrate of the first antenna unit 2 and the second antenna unit 6 has: a lateral surface used to accommodate a main element and a director, a medial surface opposite to the lateral surface, and a mid-plane that is parallel and equidistant to both the lateral surface and the medial surface. Based on the definitions of the medial surface, the lateral surface, and the mid-plane between the medial surface and the lateral surface, also referring to FIG. 28, an antenna unit array of an antenna in Embodiment 4 of the present invention may be disposed in this way: extension planes on two opposite sides of the mid-plane of each of the dielectric substrates 21 of the three first antenna units intersect to form a regular rectangular prism, and the mid-plane of the dielectric substrate 61 of the second antenna unit is located on an angle-bisecting plane in the regular triangular prism.

Also referring to FIG. 27, when the dielectric substrates 21 of all the three first antenna units and the dielectric substrate 61 of the second antenna unit are spaced apart from each other, when a straight line distance between center points of every two medial surfaces among the medial surfaces of the dielectric substrates of three first antenna units is in a range of 30-40 mm, the antenna in Embodiment 4 of the present invention is well spaced out.

Referring to FIG. 28 and FIG. 29, all main elements 22, 62 and directors 29, 69 in Embodiment 4 of the present invention are conductors instead of metal tubes of a Yagi antenna in the prior art. The conductors may be any one of the following types: a copper conductor, an aluminum conductor, a silver conductor, and the like. Further, the main elements 22, 62 and the directors 29, 69 may have the same conductor material.

Specifically, referring to a first antenna unit 2 shown in FIG. 28, the reflector 4 and the director 29 are located on two opposite sides of the main element 22 separately along an outer normal direction of the reflection surface. The location relationship between the main element 22 and the director 29 is set to: disposing the main element 22 and the director 29 consecutively along an outer normal direction vertical to the reflection surface of the reflector 4 and away from the reflection surface of the reflector 4. Each main element 22 is formed of a first conductor 23 and a second conductor 25 that are spaced out and on the same straight line, and the director 29 of the first antenna unit 2 is formed of at least one linear-shaped conductor 27. In fact, for a first antenna unit, the number of linear-shaped conductors 27 may be 2-16, and preferably 5. Each linear-shaped conductor 27 is parallel to a first conductor 23 and a second conductor 25 in the same antenna unit, and located on the same side of the main element 22 in this same antenna unit.

Specifically, referring to the second antenna unit 6 shown in FIG. 29, the location relationship between the main element 62 and the director 69 is set to: disposing the main element 62 and the director 69 consecutively along the reflection surface of the reflector 4. Each main element 62 is formed of a first conductor 62 and a second conductor 65 that are spaced out and on the same straight line, and the director 69 of the second antenna unit 6 is formed of at least one linear-shaped conductor 67. In fact, for a second antenna unit, the number of linear-shaped conductors 67 may be 2-16. When the number of linear-shaped conductors in the first antenna unit 2 is 5, the number of linear-shaped conductors in the second antenna unit is preferably 3. Each linear-shaped conductor 67 is parallel to a first conductor 63 and a second conductor 65 in the same antenna unit, and located on the same side of the main element 62 in this same antenna unit.

From FIG. 28 and FIG. 29, it can be seen that in the same antenna unit, all linear-shaped conductors are disposed consecutively and spaced apart along a direction vertical to the first conductor and the second conductor in this same antenna unit and away from the first conductor and the second conductor.

As an exemplary manner, in order to correspond to that “the operating band of the first antenna unit is greater than the operating frequency of the second antenna unit”, the number of linear-shaped conductors 27 that form the directors 29 in the first antenna unit 2 may be greater than the number of linear-shaped conductors 67 that form the directors 69 in the second antenna unit 6.

In an exemplary manner, as shown in FIG. 28, each linear-shaped conductor 27 in the first antenna unit 2 has the same material, length, width, and thickness; and a total length of the main element 22 in the first antenna unit 2 is greater than a length of each linear-shaped conductor 27 in the first antenna unit 2. As shown in FIG. 29, each linear-shaped conductor 67 in the second antenna unit 6 has the same material, length, width, and thickness; and a total length of the main element 62 in the second antenna unit 6 is greater than a length of each linear-shaped conductor 67 in the second antenna unit 6.

From FIG. 28, it can also be seen that a midperpendicular that is of each linear-shaped conductor 27 and vertical to a length direction thereof in the first antenna unit 2 is on a same straight line, and passes through a center location of the total length of the main element in the first antenna unit 2. From FIG. 29, it can also be seen that a midperpendicular that is of each linear-shaped conductor 67 and vertical to a length direction thereof in the second antenna unit 6 is on a same straight line, and passes through a center location of the total length of the main element 62 in the second antenna unit 6.

With reference to FIG. 26 to FIG. 29, the dielectric substrates 21 of the three first antenna units 2 and the dielectric substrate 61 of the second antenna unit 6 may be vertical to the reflection surface of the reflector 4. For example, both the dielectric substrate 21 and the dielectric substrate 61 are rectangles, and their length directions are vertical to the reflection surface of the reflector 4.

In addition, both the dielectric substrate 21 in the first antenna unit and the dielectric substrate 61 in the second antenna unit in Embodiment 4 of the present invention are printed circuit boards. For example, the dielectric substrates 21 and 61 may be made of FR4 materials or other substrate materials used by existing antennas. Multiple methods in the prior art may be used to form the corresponding director and main element on the corresponding dielectric substrates 21 and 61. For example, the surface of the dielectric substrates 21 and 61 is plated with a conductor layer, and then the conductor layer is etched selectively to obtain the corresponding linear-shaped conductor, the first conductor and the second conductor. Certainly, other techniques such as screen printing and laser engraving may also be used to make the conductors.

As shown in FIG. 27, the reflector 4 of the antenna in Embodiment 4 of the present invention may be a reflection board. A reflection surface of the reflection board is a conductor reflection surface. That is, the material of the reflection surface is a conductor. The conductor reflection surface is any one of the following types: a copper reflection surface, an aluminum reflection surface, an alloy reflection surface, a silver reflection surface and the like. Obviously, it can be understood that all antenna unit arrays in the antenna share one conductor reflection surface. For example, for an antenna unit array, all the dielectric substrates that form each antenna unit of the antenna unit array are fixed on the reflection surface side of the same reflector. FIG. 27 also shows that the reflection board of the antenna is preferably a circular reflection board, or may be in other shapes than a circle, such as a polygon.

In Embodiment 4 of the present invention, operation of the first antenna units may be independent of the second antenna unit, and it is acceptable that only one first antenna unit works independently. For example, in the antenna shown in FIG. 26, only one first antenna unit may work at 2.4 GHZ. Similarly, operation of the second antenna unit may be independent of all the first antenna units. For example, in the antenna shown in FIG. 26, it is acceptable that only the second antenna unit works at 5.8 GHZ and other antenna units are idle.

In the present invention, the number of antenna unit arrays is not limited to one, but may be any number. Except that the number of antenna unit arrays is different, all is the same as the scenario with one antenna unit array in Embodiment 4 of the present invention. For more than two antenna unit arrays, the location relationship between every two antenna unit arrays may depend on specific conditions, and no special requirements are imposed. In addition, preferably, all antenna unit arrays may be disposed on the same reflection surface side of the reflector.

In an actual application, the any antenna in the present invention may be applied to a fixed-line transport system, such as a metro transport system, a light rail transport system, an air transport system, a marine transport system, an expressway transport system, a submarine tunnel transport system, or a bus transport system. Obviously, the antenna in the present invention may be a bridge antenna of a vehicle-to-earth system with wireless coverage of a metro. The antenna in the present invention may be used for bridging and data transmission between a train signal and an external network signal.

### Embodiment 5

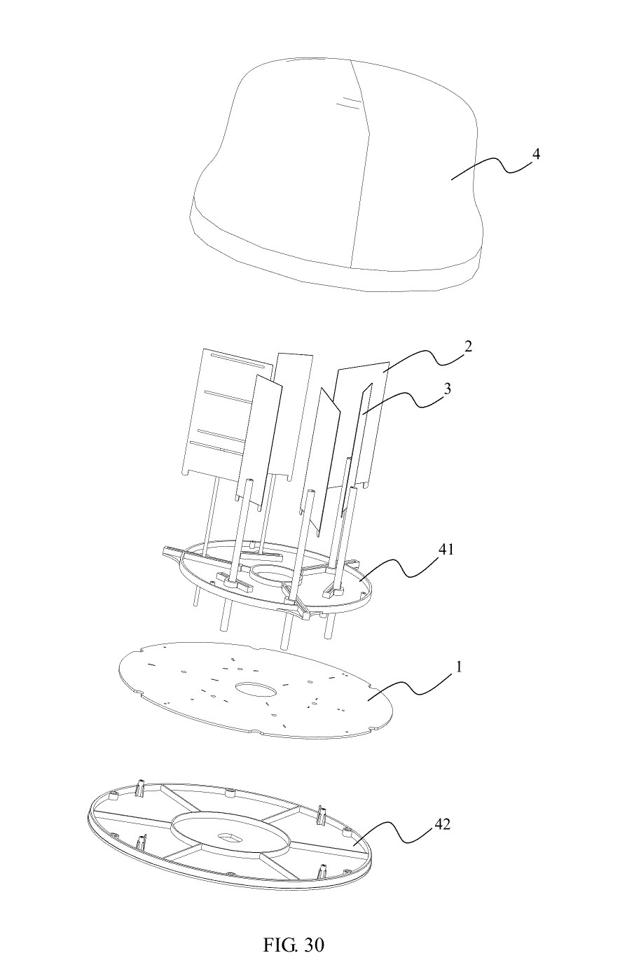

The following describes Embodiment 5 in detail with reference to FIG. 30 to FIG. 38.

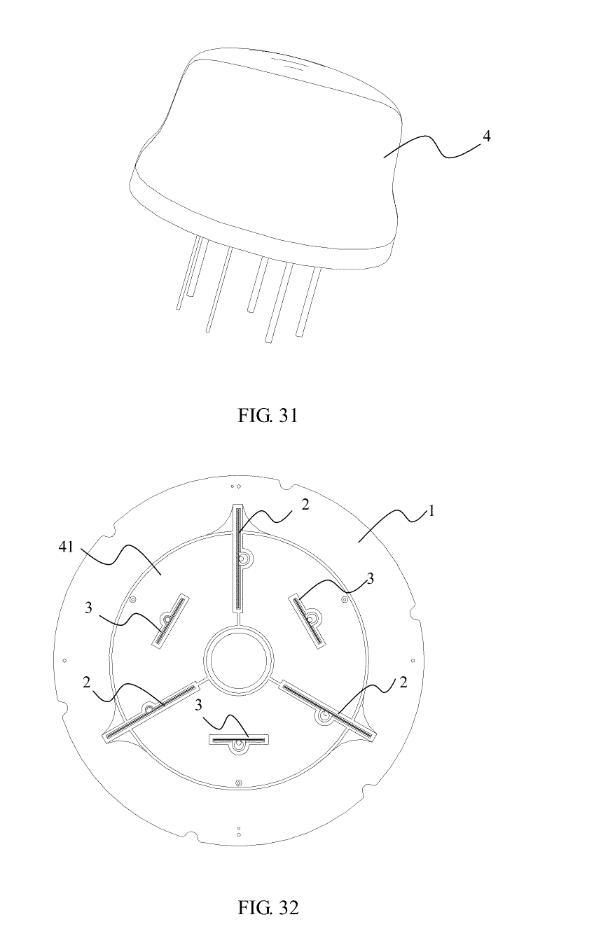

As shown in FIG. 30, an antenna in Embodiment 5 of the present invention includes an upper cover 4, a bottom cover 42, a multi-antenna assembly, and a mounting plate 41. The upper cover 4 is a bonnet case, and is fastened to a slab-shaped bottom cover 42 to form a closed cavity. The multi-antenna assembly and the mounting plate 41 are located in the cavity. An overall structure of such parts mounted is shown in FIG. 31. The antenna has advantages of being small, portable, and beautiful.

The multi-antenna assembly is shown in FIG. 30 and FIG. 32, and includes a dielectric reflection surface 1 and at least one antenna group located on the same side of the dielectric reflection surface 1. The antenna group herein is defined as a set of one or more antenna units whose operating frequencies (electromagnetic wave frequencies applied) are in the same band. Therefore, when there are multiple (including two) antenna groups, the electromagnetic wave frequencies used by the multiple antenna groups differ from each other. The different band mentioned herein refers to a frequency range applied within one channel, such as frequencies that are not less than 50 MHz apart from each other.

As shown in FIG. 30 and FIG. 32, the multi-antenna assembly in the present invention has two antenna groups, and each antenna group includes three same antenna units. Hereinafter the antenna unit with a larger size is called a first antenna unit 2, and an antenna group formed of three same first antenna units 2 is called a first antenna group; and the antenna unit with a smaller size is called a second antenna unit 3, and an antenna group formed of three same second antenna units 3 is called a second antenna group. Because the size of the first antenna unit 2 is larger than that of the second antenna unit 3, an operating frequency of an antenna formed of the first antenna unit 2 and the dielectric reflection surface 1 is lower than that of an antenna formed of the second antenna unit and the dielectric reflection surface 1. Therefore, the multi-antenna assembly in this embodiment belongs to a dual-band antenna.

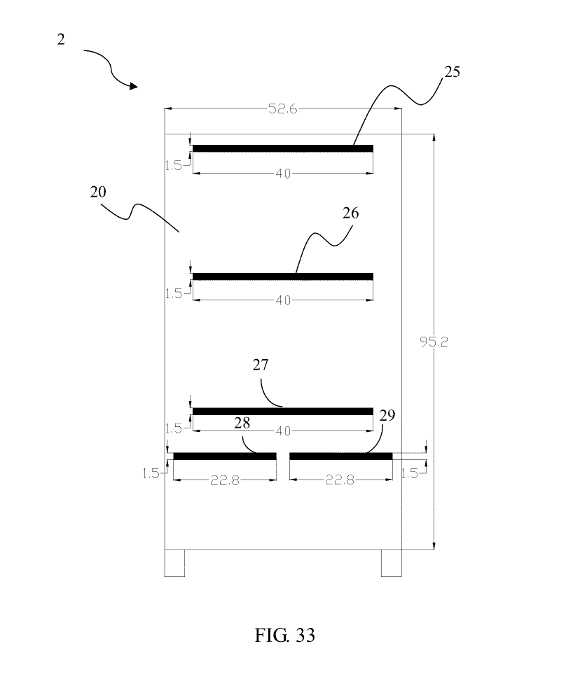

Using the first antenna unit 2 as an example, as shown in FIG. 33, the first antenna unit 2 includes a dielectric substrate 20, and a main element and a director that are attached to the dielectric substrate 20. The dielectric substrate 20 is made of FR4 and F4b materials, or other substrate materials used by existing antennas.

It should be noted that a main factor that affects the operating frequency herein is the size of the main element. Therefore, even if both the sizes of the dielectric substrates of the first antenna unit 2 and the second antenna unit 3 are the same, so long as the size of the main element of the first antenna unit 2 is larger than that of the main element of the second antenna unit 3, the operating frequency of the former is generally lower than that of the latter.

The dielectric substrate 20 of each first antenna unit 2 is vertical to the dielectric reflection surface 1, and is first mounted on the mounting plate 41 fixedly in a plugging manner, and then pins of each antenna unit pass through the mounting plate 41, the dielectric reflection surface 1, and the bottom cover 42, so as to connect to an external circuit. Each antenna unit is mounted in such a way that the directors and the dielectric reflection surface 1 of the antenna unit are separately located on two sides of the main element of the antenna unit.

The main element is used to connect to a feeder, and includes two conductor wires which are a first conductor wire 28 and a second conductor wire 29, where the first conductor wire 28 is electrically connected to an outer conductor of a coaxial feeder cable, and the second conductor wire 29 is electrically connected to a core wire of the coaxial feeder cable. Obviously, the location of the first conductor wire 28 is interchangeable with that of the second conductor wire 29.

As shown in FIG. 33, the first conductor wire 28 and the second conductor wire 29 are on the same straight line, and are spaced apart from each other.

The director may be one or more, and is a conductor wire attached to a surface of the dielectric substrate 20. When there are multiple directors, all conductor wires that form the directors are parallel to each other, and located on the same side of the main element, and are used to enhance electromagnetic wave strength on this side of the main element. A specific structure is shown in FIG. 33. A third conductor wire 25, a fourth conductor wire 26, and a fifth conductor wire 27 in FIG. 33 form three directors. The three directors are arranged parallel to each other, and are parallel to the first conductor wire 28 and the second conductor wire 29 that form the main element. The three directors may have the same length or different lengths. For a better effect of directing electromagnetic waves, same-length directors are preferably selected. In addition, the number of directors may be three, or may be two or even one, or more than three. Generally, if there are more than five directors, impact on an electromagnetic field changes scarcely. In order to save space and materials, and three directors are preferably used.

Preferably, three center points of the third, fourth and fifth conductors 25, 26 and 27 are on one straight line, and the straight line is vertical to any of the three conductor wires. In addition, the straight line on which the main element is located is parallel to any one of the foregoing conductor wires, and a total length of the main element is greater than that of any one of the foregoing conductor wires. Preferably, the center of the main element and three center points of the first, second and three conductor wires are on the same straight line.

The first to fifth conductor wires are all made of conductive materials, preferably metal wires such as copper and aluminum.

Similarly, the second antenna unit 3 also has a similar structure, and also includes a dielectric substrate 30, and a first conductor wire 38 and a second conductor wire 39 that are attached as a main element onto the dielectric substrate 30, and a third conductor wire 35, a fourth conductor wire 36, and a fifth conductor wire 37 that serve as directors. The foregoing descriptions about each conductor wire and dielectric substrate are all applicable to the corresponding part of the second antenna unit 3.

The antenna unit with such a structure can form a structure similar to a Yagi antenna after a reflector is mounted on the other side of the main element. A Yagi antenna, also called a Yagi-Uda antenna, is generally in a shape of “ [symbol] ”. A main element (also called an active element) is located at the center of the “ [symbol] ”, and is connected to a feeder. A reflector is located on a side of the main element to serve a purpose of weakening electromagnetic waves on this side, and is a little longer than the main element. A director is located on the other side of the main element, and is a little shorter than the main element and is used to enhance electromagnetic waves on this side.

The dielectric reflection surface 1 and the directors on each antenna unit are separately located on two sides of the main element of the antenna unit, and form a miniature Yagi antenna as a whole. The dielectric reflection surface 1 is the reflector. Using the first antenna unit 2 as an example, the first conductor wire 28 and the second conductor wire 29 of the main element form the active element, and the third, fourth and fifth conductor wires 25, 26, 27 form three directors. Because the main element and the directors in the present invention are all in the form of conductor wires instead of metal tubes, the size is much smaller and the structure is more compact, and the antenna has high directivity of Yagi antennas. In addition, multiple antenna units 2, 3 share one dielectric reflection surface 1, which also saves much space and reduces the size of the antenna.

The dielectric reflection surface 1 herein is used to reflect radio waves used by any antenna unit 4, and the used radio waves refer to electromagnetic waves generated by each antenna unit or electromagnetic waves received by each antenna unit. In some embodiments, the dielectric reflection surface 1 may be made of copper or other conductive materials, and may be a non-planar surface. It can be understood that the dielectric reflection surface 1 may have discontinuous points, for example, a dielectric surface is processed into a mesh structure or perforated into holes or the like to implement a function of reflecting radio waves, where the size of the mesh structure or the holes is less than one-tenth of the radio wave wavelength used by the multi-antenna assembly.

As shown in FIG. 32, the three first antenna units 2 are 120 degrees apart from each other, use the same straight line as an extension intersection line of surfaces of the three dielectric substrates, and the three first antenna units 2 are equidistant to the extension intersection line. It may also be construed as that, as seen from the top view shown in FIG. 32, the three first antenna units 2 use the same point as a rotation center, and any first antenna unit rotates 120 degrees around the rotation center to coincide with another first antenna unit 2.

The three second antenna units 3 are arranged in a manner shown in FIG. 32, that is, are 60 degrees apart from each other, and dielectric substrates of the three second antenna units 3 intersect to form an equilateral triangle after extending along a surface direction. In addition, as shown in FIG. 32, a second antenna unit 3 is disposed between every two first antenna units 2, and the two first antenna units 2 are symmetrically located on both sides of the second antenna unit 3 so that the three first antenna units 2 are located at three adjacent spacings of the three second antenna units 3 consecutively.

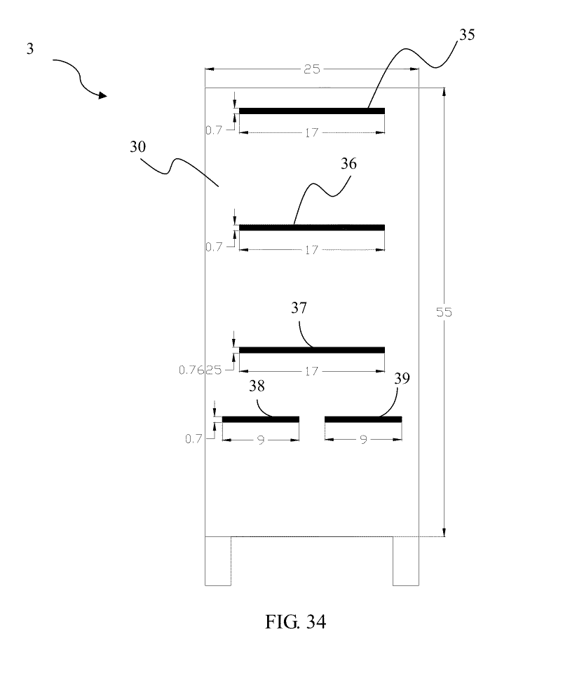

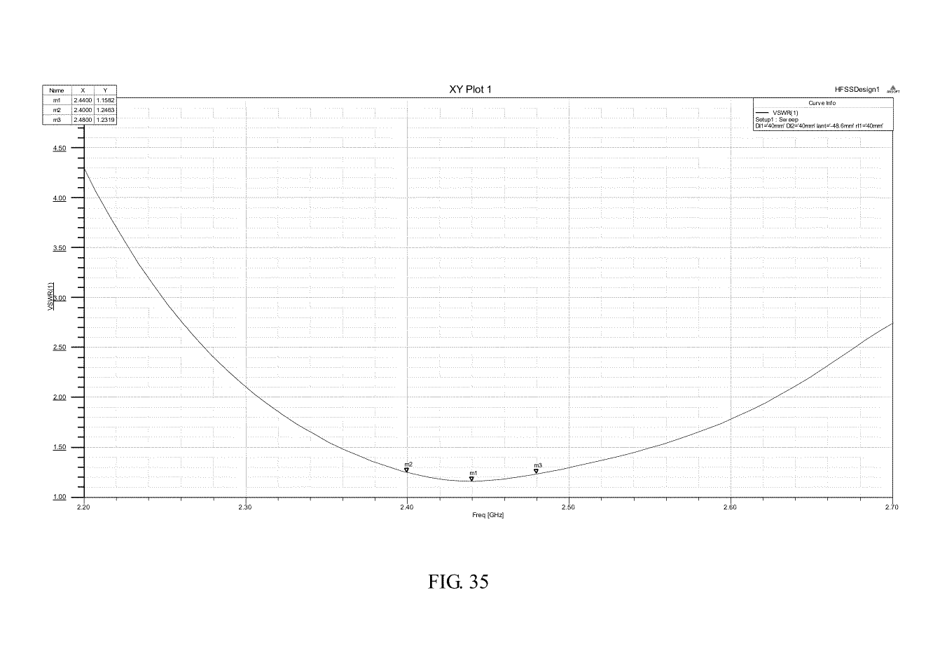

To verify effects of the antenna assembly and the multi-antenna assembly in the present invention, a specific embodiment is given as an example, in which sizes of a first antenna unit 2 and a second antenna unit 3 are shown in FIG. 33 and FIG. 34, a dielectric substrate 20 of the first antenna unit 2 is 95.2 mm long and 52.6 mm wide, both a first conductor wire 28 and a second conductor wire 29 are 22.8 mm long and 1.5 mm wide, and a third conductor wire 25, a fourth conductor wire 26 and a fifth conductor wire 27 are all 40 mm long and 1.5 mm wide. The first antenna unit 2 and the second antenna unit 3 have dielectric substrates 20 that are 55 mm long and 25 mm wide, a first conductor wire 38 and a second conductor wire 39 that are both 9 mm long and 0.7 mm wide, and a third conductor wire 35, a fourth conductor wire 36 and a fifth conductor wire 37 that are all 17 mm long and 0.7 mm wide. The dielectric reflection surface 1 is a copper foil with a diameter of 80 mm. FIG. 35 to FIG. 38 show emulation performed by using the multi-antenna assembly that is of the foregoing size and arranged in a manner shown in FIG. 30 and FIG. 32.

FIG. 35 is a low-band standing wave ratio emulation diagram. Three points m1, m2, and m3 marked in FIG. 35 have the following coordinate parameters in the emulation diagram:

| Name | X (GHz) | Y |
|---|---|---|
| m1 | 2.4400 | 1.1582 |
| m2 | 2.4000 | 1.2463 |
| m3 | 2.4800 | 1.2319 |

The foregoing table shows that the multi-antenna assembly has very good impedance matching in a band range of 2.400˜2.4800 GHz.

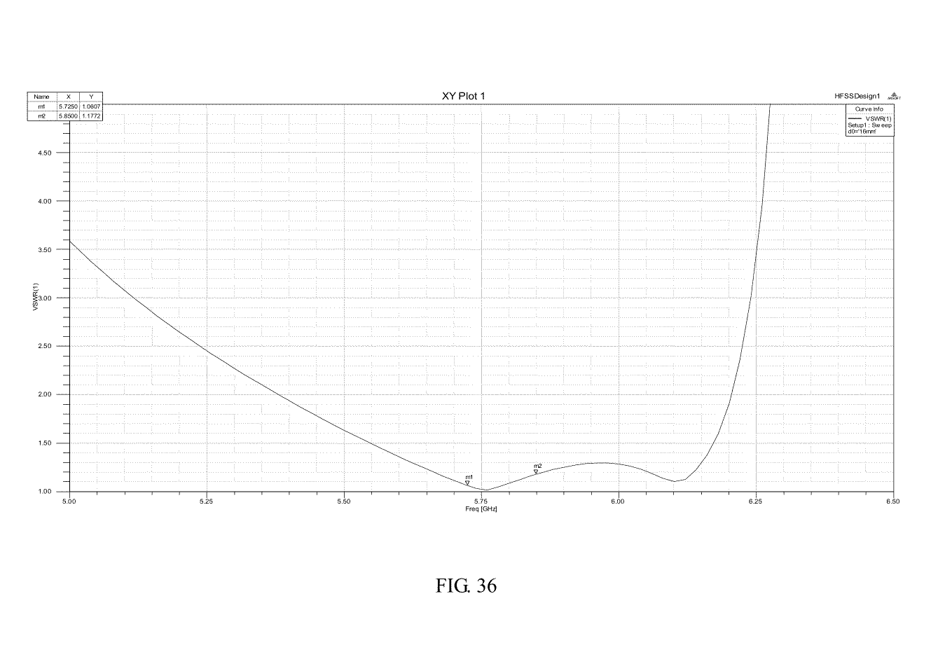

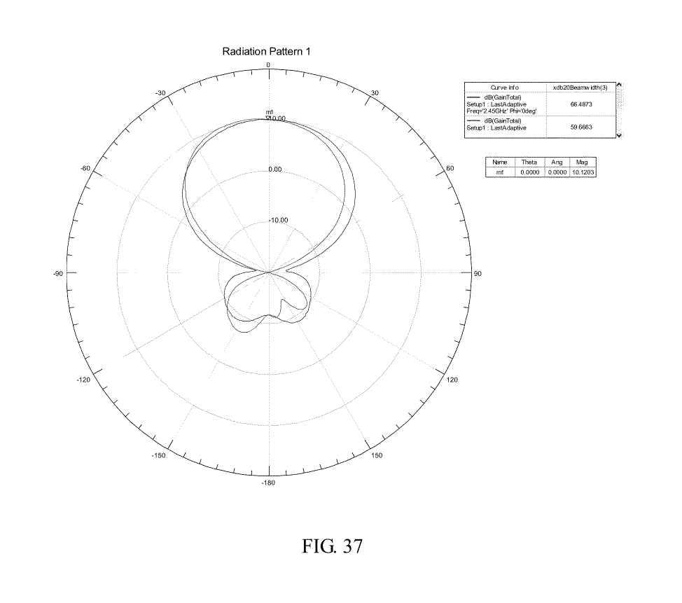

FIG. 36 is a directivity diagram of the foregoing multi-antenna assembly in an electromagnetic field with a frequency of 2.45 GHz. As shown in the figure, emission at this frequency has high directivity, which can satisfy radio signal receiving and transmitting requirements.

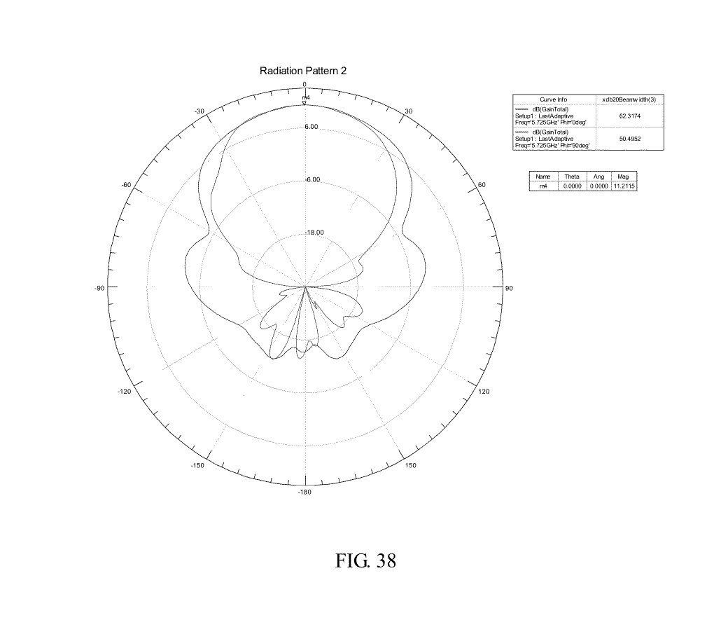

FIG. 37 is a high-band standing wave ratio emulation diagram. Two points m1 and m2 marked in FIG. 37 have the following coordinate parameters in the emulation diagram:

| Name | X (GHz) | Y |
|---|---|---|
| m1 | 5.7250 | 1.0607 |
| m2 | 5.8500 | 1.1772 |

The foregoing table shows that the multi-antenna assembly has very good impedance matching in a band range of 5.725˜5.8500 GHz.

FIG. 38 is a directivity diagram of the foregoing multi-antenna assembly in an electromagnetic field with a frequency of 5.725 GHz. As shown in the figure, emission at this frequency has high directivity, which can satisfy radio signal receiving and transmitting requirements.

In conclusion, the antenna designed according to Yagi antenna principles has high directivity, belongs to a dual-band antenna because operating bands are two bands: 2.4 GHz and 5.8 GHz, and has advantages of broad bands, high gains, and easy commissioning. Obviously, when the multi-antenna assembly in the present invention has three or more antenna groups, a multi-band antenna can be obtained, which also falls within the protection scope of the present invention. Similarly, each antenna group in the present invention does not necessarily include three antenna units, but may include only one antenna unit, or two or more than three antenna units. The antenna unit is not necessarily arranged by evenly sectioning the space on the side of the dielectric reflection surface, but may be disposed in other manners such as being parallel to each other.

The foregoing describes the embodiments of the present invention with reference to the accompanying drawings. However, the present invention is not limited to the foregoing specific implementation manners. The foregoing specific implementation manners are merely exemplary rather than restrictive. In light of the present invention, persons of ordinary skill in the art may develop many other manners without departing from principles of the present invention and the protection scope of the claims, and all such manners fall within the protection scope of the present invention.

What is claimed is:

1. An antenna unit, comprising a dielectric substrate and an antenna conductor attached to the dielectric substrate, wherein a maximum gain direction of the antenna unit is consistent with an extension direction of a surface of the dielectric substrate.

2. The antenna unit according to claim 1, wherein the antenna conductor comprises a main element used for connecting to a feeder, and a director used to enhance a radio wave on a radio side, wherein both the main element and the director are conductor wires attached to the dielectric substrate, wherein the conductor wire is a metal wire, wherein there are multiple directors, which constitute a group of conductor wires that are parallel to each other, wherein centers of the multiple directors are on a same straight line, and the straight line is vertical to the directors.

3. The antenna unit according to claim 2, wherein the director is a radial structure that is formed of a conductor material and disposed along a propagation direction of an electromagnetic wave, wherein the dielectric substrate comprises two surfaces, and at least one director is disposed on another surface that is different from a surface on which the main element is located, wherein the main element comprises two collinear conductor wires, which are parallel to the conductor wires of the directors respectively, wherein a total length of the main element is greater than a length of each director.

4. The antenna unit according to claim 1, wherein the antenna conductor comprises a first antenna conductor disposed on one surface of the dielectric substrate and a second antenna conductor that is disposed on another surface, wherein the antenna unit comprises multiple layers of dielectric substrates, and the antenna conductor is disposed on one or more of the multiple layers of dielectric substrates.

5. The antenna unit according to claim 1, wherein the antenna conductor comprises a main element and at least one director that are disposed apart on a surface of the dielectric substrate, both the main element and the director are conductor strips, and both ends of the main element are a feed point and a ground point respectively, wherein the main element is a splayed curve ring or a splayed polyline ring, and the feed point and the ground point are located at ends of a splay separately, wherein some of the conductor strips at the splay have overlaps, and the overlaps are spaced apart to form the splay, wherein the conductor strips with the overlaps take on two opposite L shapes, wherein the conductor strips are metal wires, wires formed of a nonmetal conductive substance, or conductive wires formed of a metal and a nonmetal, wherein there are multiple directors, which constitute a group of conductor strips that are parallel to each other, wherein the dielectric substrate comprises two surfaces, and at least one director is disposed on another surface that is different from a surface on which the main element is located.

6. A multi-antenna assembly, comprising a dielectric reflection surface and at least one antenna group installed on the dielectric reflection surface, wherein radio wave frequencies used by different antenna groups are different, and each antenna group comprises at least one antenna unit according to claim 1.

7. The multi-antenna assembly according to claim 6, wherein the dielectric reflection surface is a conductive microstructure with a geometric pattern, wherein a size of the conductive microstructure is less than one-sixth of a wavelength corresponding to a radio wave frequency used by the antenna group.

8. The multi-antenna assembly according to claim 6, wherein the antenna conductor comprises a main element used for connecting to a feeder, and a director used to enhance a radio wave on a radio side, wherein both the main element and the director are conductor wires attached to the dielectric substrate, wherein the multi-antenna assembly comprises two antenna groups which are a first antenna group and a second antenna group, and main elements of antenna units of the two antenna groups have different sizes, wherein the first antenna group and the second antenna group comprise the same number of antenna units, and antenna units of the first antenna group are spaced apart by antenna units of the second antenna group.

9. The multi-antenna assembly according to claim 6, wherein the antenna conductor comprises a main element used for connecting to a feeder, and a director used to enhance a radio wave on a radio side, wherein both the main element and the director are conductor wires attached to the dielectric substrate, wherein the multi-antenna assembly comprises two antenna groups which are a first antenna group and a second antenna group, the first antenna group and the second antenna group comprise their respective same antenna units, and their respective antenna units are evenly distributed on the dielectric reflection surface in an angular array manner, wherein a reflector is disposed outside each antenna unit, wherein the reflector is a splayed structure that is small at one end and big at the other end, and the splay is oriented to a maximum gain direction of the antenna unit.

10. The multi-antenna assembly according to claim 6, wherein the antenna conductor comprises a main element used for connecting to a feeder, and a director used to enhance a radio wave on a radio side, wherein both the main element and the director are conductor wires attached to the dielectric substrate, wherein a dielectric reflection surface thereof and a director of each antenna unit are separately located on two sides of a main element of a corresponding antenna unit, the multi-antenna assembly comprises two antenna groups which are a first antenna group and a second antenna group, and a size of a main element of an antenna unit of the former is larger than a size of a main element of an antenna unit of the latter.

11. The multi-antenna assembly according to claim 10, wherein the first antenna group and the second antenna group each comprise three same antenna units, a dielectric substrate of each antenna unit is vertical to the dielectric reflection surface, the three antenna units of the first antenna group are 120 degrees apart from each other, use a same straight line as an extension intersection line and are equidistant to the extension intersection line, and the three antenna units of the second antenna group are 60 degrees apart from each other and dielectric substrates of the three antenna units intersect to form an equilateral triangle after extending along a surface direction, wherein the three antenna units of the second antenna group are located at three adjacent spacings of the three antenna units of the first antenna group consecutively.

12. A multi-antenna assembly, comprising a dielectric reflection board used to reflect radio waves used by the multi-antenna assembly, and at least one antenna group located on a side of the dielectric reflection board, wherein the antenna group comprises at least one antenna unit according to claim 1, wherein the antenna conductor comprises a main element used for connecting to a feeder, and a director used to enhance a radio wave on a radio side, wherein both the main element and the director are conductor wires attached to the dielectric substrate, and the dielectric reflection board and a director of each antenna unit are separately located on two sides of a main element of a corresponding antenna unit.

13. The multi-antenna assembly according to claim 12, wherein the multi-antenna assembly comprises a first antenna group and a second antenna group that have a same quantity of antenna units, and antenna units of the first antenna group are spaced apart by antenna units of the second antenna group, wherein the first antenna group and the second antenna group comprise their respective same antenna units, and their respective antenna units are evenly distributed on the dielectric reflection board in an angular array manner, wherein the first antenna group and the second antenna group each comprise three antenna units.

14. The multi-antenna assembly according to claim 12, wherein the multi-antenna assembly comprises a reflector with the dielectric reflection surface and at least one antenna unit array disposed on the dielectric reflection surface, the antenna unit array comprises two antenna groups which are a first antenna group and a second antenna group, the first antenna group comprises multiple first antenna units with a first operating band, the second antenna group comprises at least one second antenna unit with a second operating band, the multiple first antenna units form a circle around, and the second antenna unit is located in the circle of the first antenna units, wherein both the first antenna units and the second antenna unit have a dielectric substrate that is vertically fixed on a side of the same reflection surface, and a main element and a director that are formed on the dielectric substrate.

15. The multi-antenna assembly according to claim 14, wherein the number of first antenna units is three, midperpendicular planes that are of dielectric substrates of the three first antenna units and vertical to the reflection surface converge on a line, and an angle between every two adjacent midperpendicular planes is 120°; and a dielectric substrate of the second antenna unit is vertical to a dielectric substrate of one of the first antenna units.

16. The multi-antenna assembly according to claim 15, wherein among medial surfaces of the dielectric substrates of the three first antenna units, a straight-line distance between center points of every two medial surfaces falls within a range of 30-40 mm.

17. The multi-antenna assembly according to claim 16, wherein other two dielectric substrates among the dielectric substrates of the three first antenna units are disposed in a mirrored relation to the dielectric substrate of the second antenna unit.

18. The multi-antenna assembly according to claim 17, wherein each main element is formed of a first conductor and a second conductor that are spaced apart on a same straight line, and both the directors of the first antenna units and the director of the second antenna unit are formed of at least one linear-shaped conductor; in a same antenna unit, each linear-shaped conductor is parallel to the first conductor and the second conductor in the same antenna unit and located on a same side of a main element in the same antenna unit, wherein the director of the first antenna unit and the director of the second antenna unit are formed of 2-16 conductors; in the same antenna unit, all linear-shaped conductors are spaced apart along a direction vertical to the first conductor and the second conductor in the same antenna unit, wherein the number of linear-shaped conductors that form the directors in the first antenna unit is greater than the number of linear-shaped conductors that form the directors in the second antenna unit.

19. The multi-antenna assembly according to claim 18, wherein each linear-shaped conductor in the first antenna unit is the same, and a total length of the main element in the first antenna unit is greater than a length of each linear-shaped conductor in the first antenna unit, wherein a midperpendicular that is of each linear-shaped conductor and vertical to a length direction thereof in the first antenna unit is on a same straight line, and passes through a center location of the total length of the main element in the first antenna unit.

20. The multi-antenna assembly according to claim 18, wherein each linear-shaped conductor in the second antenna unit is the same, and a total length of the main element in the second antenna unit is greater than a length of each linear-shaped conductor in the second antenna unit, wherein a midperpendicular that is of each linear-shaped conductor and vertical to a length direction thereof in the second antenna unit is on a same straight line, and passes through a center location of the total length of the main element in the second antenna unit.
